(19) United States
(12) Patent Application Publication
(10) Pub. No.: US 2007/0139771 A1
(43) Pub. Date: Jun. 21, 2007

(54) Optical retarders and methods of making the same

(76) Inventors: Jian Wang, Orefield, PA (US); Xuegong Deng, Piscataway, NJ (US)

Correspondence Address: FISH & RICHARDSON PC, P.O. BOX 1022, MINNEAPOLIS, MN, 55440-1022, US

(21) Appl. No.: 11/304,087

(22) Filed: Dec. 15, 2005

(51) Int. Cl. G02B 5/30

(52) U.S. Cl. 359/494

(57) ABSTRACT

In certain aspects, the disclosure features an article that includes a first layer having spaced-apart rows of a first material, and a multilayer film adjacent the first layer. The first layer and the multilayer film are each independently birefringent for light of a wavelength λ propagating along an axis that intersects the first layer and the multilayer film, and λ is in a range from about 150 nm to about 5,000 nm.

### TECHNICAL FIELD

This disclosure relates to optical devices, and more particularly to optical retarders.

### BACKGROUND

Optical devices and optical systems are commonly used where manipulation of light is desired. Examples of optical devices include lenses, polarizers, optical filters, antireflection films, retarders (e.g., quarter-waveplates), and beam splitters (e.g., polarizing and non-polarizing beam splitters).

### SUMMARY

In general, in a first aspect, the invention features an article that includes a first layer including spaced-apart rows of a first material, and a second layer supported by the first layer, the second layer including spaced-apart rows of a second material, where the rows of the first layer extend along a first direction and the rows of the second layer extend along a second direction non-parallel with the first direction, and each layer is independently birefringent for light of a wavelength λ propagating along an axis that intersects the first and second layers, where λ is in a range from about 150 nm to about 5,000 nm.

Embodiments of the article may include one or more of the following features and/or features of other aspects.

The first and second materials may be different.

At least one of the first and second materials may be a dielectric material, and the dielectric material may be selected from a group consisting of SiO₂, SiNₓ, Si, Al₂O₃, ZrO₂, Ta₂O₅, TiO₂, HfO₂, Nb₂O₅, and MgF₂.

At least one of the first and second materials may be a nanolaminate material, and may include one or more materials selected from a group consisting of SiO₂, SiNₓ, Si, Al₂O₃, ZrO₂, Ta₂O₅, TiO₂, HfO₂, Nb₂O₅, and MgF₂.

The article may further include a third layer supported by the second layer and including spaced-apart rows of a third material extending along a third direction that is non-parallel with at least one of the first and second directions, where the third layer is birefringent for light of wavelength λ propagating along an axis that intersects the first, second, and third layers. For example, the third direction of the rows of the third material may be parallel with one of the first and second directions, or the third direction of the rows of the third material may be non-parallel with both of the first and second directions. At least one of the first, second, and third materials may include a dielectric material selected from a group consisting of SiO₂, SiNₓ, Si, Al₂O₃, ZrO₂, Ta₂O₅, TiO₂, HfO₂, Nb₂O₅, and MgF₂. Further, each of the first, second, and third materials may be a nanolaminate material independently selected from the group consisting of SiO₂, SiNₓ, Si, Al₂O₃, ZrO₂, Ta₂O₅, TiO₂, HfO₂, Nb₂O₅, and MgF₂.

The first layer may include rows of a third material alternating with the spaced-apart rows of the first material and extending along the first direction, the third material being different from the first material. The third material may define a substrate, the rows of the third material may be defined by walls of trenches within the substrate, and the first material may be disposed within the trenches. The first and third materials may be dielectric materials. For example, the first material may be selected from the group consisting of SiO₂, SiNₓ, Si, Al₂O₃, ZrO₂, Ta₂O₅, TiO₂, HfO₂, Nb₂O₅, and MgF₂. The first material may further be a nanolaminate material. A layer of the first material may be disposed between the rows of the first layer and the rows of the second layer. The layer of the first material may be contiguous with the rows of the first material of the first layer. An antireflection film may be disposed between the layer of the first material and the rows of the second material of the second layer.

The second layer may include rows of a fourth material alternating with the spaced-apart rows of the second material and extending along the second direction, the fourth material being different from the second material. The fourth material may define a substrate, the rows of the fourth material may be defined by walls of trenches within the substrate, and the second material may be disposed within the trenches. The second and fourth materials may be dielectric materials. The first material and second materials may include one or more materials selected from the group consisting of SiO₂, SiNₓ, Si, Al₂O₃, ZrO₂, Ta₂O₅, TiO₂, HfO₂, Nb₂O₅, and MgF₂.

An angle between the first and second directions may be at least about 10°. For example, the angle may be at least about 20°. The angle may be about 80° or less. For example, the angle may be about 70° or less.

An angle between the first and second directions may be about 80° or less. For example, the angle may be about 70° or less.

The first layer may be a monolithic layer. The first material of the first layer may be a nanolaminate material. The second layer may be a monolithic layer.

An antireflection film may be disposed between the first and second layers.

The first and second layers may each independently have an optical retardation of at least about 1 nm for light of the wavelength λ. For example, the first and second layers may each independently have an optical retardation of at least about 5 nm for light of the wavelength λ, or the first and second layers may each independently have an optical retardation of at least about 10 nm for light of the wavelength λ, or the first and second layers each independently have an optical retardation of at least about 50 nm for light of the wavelength λ.

The wavelength λ may be between about 400 nm and about 700 nm.

The wavelength λ may be between about 1,200 nm and about 1,600 nm.

One of the first and second layers may have an optical retardation that is greater than the optical retardation of the other layer, and a difference between the optical retardations of the first and second layers may be at least about 1 nm for light of the wavelength λ. The wavelength λ may be between about 400 nm and about 700 nm.

One of the first and second layers may have an optical retardation that is greater than the optical retardation of the other layer, and a difference between the optical retardations of the first and second layers may be at least about 5 nm for light of the wavelength λ.

A combined thickness of the first and second layers may be about 9 microns or less. For example, the combined thickness may be about 6 microns or less, or about 3 microns or less. The first and second layers may each independently have a thickness of about 5 microns or less. For example, the first and second layers may each independently have a thickness of about 1 micron or less, or about 500 nm or less.

Centers of successive rows of the first layer may be spaced apart by about 400 nm or less. For example, centers of successive rows of the first layer may be spaced apart by about 200 nm or less.

The first layer may retard incident radiation at wavelength λ by an amount Γ₁, the second layer may retard incident radiation at wavelength λ by an amount Γ₂, and Γ₁ and Γ₂ may each be at least about π/4. For example, at least one of Γ₁ and Γ₂ may be at least about π/2. As another example, one of Γ₁ and Γ₂ may be about π/4 and the other of Γ₁ and Γ₂ may be about π/2. A third layer may be supported by the second layer and may include spaced-apart rows of a third material extending along a third direction that is non-parallel with at least one of the first and second directions, the third layer may be birefringent for light of wavelength λ propagating along an axis that intersects the first, second, and third layers, and the third layer may retard incident radiation at wavelength λ by an amount Γ₃ that is at least about π/4. For example, at least one of Γ₁, Γ₂, and Γ₃ may be at least about π/2. The third direction may be non-parallel with both of the first and second directions. The article may retard incident radiation at wavelengths λ₁ and λ₂ by respective amounts Γ₁ and Γ₂, where |λ₁−λ₂| may be at least about 15 nm, and Γ₁ and Γ₂ may be substantially equal.

The article may retard incident radiation at wavelengths λ₁ and λ₂ by respective amounts Γ₁ and Γ₂, where |λ₁−λ₂| may be at least about 15 nm, Γ₁ and Γ₂ may be substantially equal, and both λ₁ and λ₂ may be in a range from about 150 nm to about 5,000 nm. For example, |λ₁−λ₂| may be at least about 30 nm, or at least about 75 nm, or at least about 100 nm, or at least about 200 nm. The difference in retardance expressed by |Γ₁−Γ₂| may be about 0.03π or less, for example, such as about 0.02π or less, or about 0.01π or less. A system that includes the article may also include a polarizer, where the article and polarizer are configured so that during operation the polarizer substantially polarizes radiation of wavelengths λ₁ and λ₂ prior to the radiation being received by the article. The article may transmit radiation received by the article and the system may further include a second polarizer configured so that during operation the second polarizer receives radiation after the radiation is transmitted by the article.

A system that includes the article may also include a polarizer, where the article and polarizer are configured so that during operation the polarizer substantially polarizes radiation of a wavelength λ prior to the radiation being received by the article. The article may transmit radiation received by the article and the system may further include a second polarizer configured so that during operation the second polarizer receives radiation after the radiation is transmitted by the article.

In another aspect, the invention features an article that includes a first layer including spaced-apart rows of a first material, the centers of adjacent rows of the first material being spaced apart by about 400 nm or less, and a second layer supported by the first layer, the second layer comprising spaced-apart rows of a second material, the centers of adjacent rows of the second material being spaced apart by about 400 nm or less, where the rows of the first layer extend along a first direction and the rows of the second layer extend along a second direction non-parallel with the first direction.

Embodiments of the article may include one or more of the following features and/or features of other aspects. The article may retard incident radiation at wavelengths λ₁ and λ₂ by respective amounts Γ₁ and Γ₂, where |λ₁−λ₂| may be at least about 15 nm, Γ₁ and Γ₂ may be substantially equal, and both λ₁ and λ₂ may be between about 150 nm and about 5,000 nm. For example, |λ₁−λ₂| may be at least about 30 nm. At least one of the first and second materials may include at least one dielectric material selected from a group consisting of SiO₂, SiNₓ, Si, Al₂O₃, ZrO₂, Ta₂O₅, TiO₂, HfO₂, Nb₂O₅, and MgF₂.

At least one of the first and second materials may be a nanolaminate material.

In another aspect, the invention features an article that includes a first layer comprising spaced-apart rows of a first material, and a second layer supported by the first layer, the second layer comprising spaced-apart rows of a second material, where the rows of the first layer extend along a first direction and the rows of the second layer extend along a second direction non-parallel with the first direction, and the article retards incident radiation at wavelengths λ₁ and λ₂ by respective amounts Γ₁ and Γ₂, where |λ₁−λ₂| is at least about 15 nm, Γ₁ and Γ₂ are substantially equal, and both λ₁ and λ₂ are in a range from about 150 nm to about 5,000 nm.

Embodiments of the article may include one or more of the following features and/or features of other aspects. At least one of the first and second materials may be a nanolaminate material. At least one of the first and second materials may include at least one dielectric material selected from a group consisting of SiO₂, SiNₓ, Si, Al₂O₃, ZrO₂, Ta₂O₅, TiO₂, HfO₂, Nb₂O₅, and MgF₂.

In another aspect, the invention features an article that includes a form birefringent grating oriented along a first direction, and a second grating supported by the form birefringent grating and oriented along a second direction non-parallel with the first direction, where the article is birefringent for light of a wavelength λ incident on the article, where λ is in a range from about 150 nm to about 5,000 nm.

Embodiments of the article may include one or more of the following features and/or features of other aspects. The form birefringent grating can include rows formed of a dielectric material and extending along the first direction. The rows may be separated by trenches, and the trenches may be filled with a nanolaminate material. The second grating may be a form birefringent grating.

The form birefringent grating and the second grating may be spaced apart by about 2 microns or less.

In another aspect, the invention features an article that includes a first layer including spaced-apart rows of a nanolaminate material, the rows of nanolaminate material extending along a first direction, and a second layer supported by the first layer, the second layer including spaced-apart rows of a second material extending along a second direction non-parallel with the first direction. Embodiments of the article may include one or more of the features of other aspects.

In another aspect, the invention features a method that includes disposing a first layer over a second layer, the first layer including spaced-apart rows of a first material and the second layer including spaced-apart rows of a second material, each layer being independently birefringent for light of a wavelength λ propagating along an axis that intersects that layer, where disposing the first layer over the second layer includes disposing the rows of the first layer along a first direction and disposing the rows of the second layer along a second direction non-parallel with the first direction, and where λ is in a range from about 150 nm to about 5,000 nm.

Embodiments of the method may include one or more of the following features and/or features of other aspects. The method may further include forming the spaced-apart rows of the second material. Forming the spaced-apart rows of the second material may include depositing the second material within each of multiple spaced-apart trenches disposed within a substrate. The second material may be deposited using atomic layer deposition. Alternatively, depositing the second material may include forming the second material as a nanolaminate within the spaced-apart trenches.

The method may further include forming the spaced-apart rows of the first material. The substrate may be a second substrate and forming the spaced-apart rows of the first material may include depositing the first material within each of multiple spaced-apart trenches disposed within a first substrate, where the trenches of the first substrate extend along the first direction and the trenches of the second substrate extend along the second direction. The first material may be deposited in the trenches using atomic layer deposition. Alternatively, depositing the first material may include forming the first material as a nanolaminate within the spaced-apart trenches of the first substrate. Disposing the first layer over the second layer may include depositing the first substrate over the second layer.

The method may further include forming a second material layer of the second material prior to disposing the first layer over the second layer, the second material layer being formed over the spaced-apart rows of the second material within the trenches, and where disposing the first layer over the second layer includes disposing the first layer over the second material layer.

The method may further include forming an antireflection film on at least one of the first and second layers, where disposing the first layer over the second layer includes disposing the first layer over the second layer so that the antireflection layer is between the first and second layers.

In another aspect, the invention features a method that includes forming a first layer including spaced-apart rows of a first material using atomic layer deposition, the rows of the first material extending along a first direction, and disposing a second layer over first layer, the second layer including spaced-apart rows of a second material extending along a second direction non-parallel with the first direction.

Embodiments of the method may include one or more of the following features and/or features of other aspects. The first material may be a nanolaminate material.

Forming the spaced-apart rows of the first material may include depositing the first material within each of multiple spaced-apart trenches, the trenches extending along the first direction. Forming the spaced-apart rows of the first material may further include depositing a layer of the first material that extends over at least some of the spaced-apart rows of the first material. Disposing the second layer over the rows of first material may include forming the spaced-apart rows of the second material over the first layer, and may further include forming an antireflection film over the first layer prior to forming the spaced-apart rows of the second material. Forming the spaced-apart rows of the second material may include depositing the second material within each of multiple spaced-apart trenches that extend along the second direction. The second material may be a nanolaminate material.

In another aspect, the invention features an article that includes a first grating that is form birefringent for light having a wavelength λ less than about 2000 nm, and a second grating positioned adjacent the first grating, the second grating also being form birefringent for light having a wavelength λ, where the article is an achromatic retarder for light in a range of wavelengths less than 2000 nm incident on the article along a path that intersects both the first and second gratings.

Embodiments of the article may include one or more of the following features and/or features of other aspects.

In another aspect, the invention features an article that includes a first layer including spaced-apart rows of a first material, and a multilayer film adjacent the first layer, where the first layer and the multilayer film are each independently birefringent for light of a wavelength λ propagating along an axis that intersects the first layer and the multilayer film, and λ is in a range from about 150 nm to about 5,000 nm.

Embodiments of the article may include one or more of the following features and/or features of other aspects. The article may further include a substrate supporting the first layer and the multilayer film. The first layer and the multilayer film may be disposed on opposite sides of the substrate. Alternatively, the first layer and the multilayer film may be disposed on the same side of the substrate. The article may further include a second multilayer film disposed on an opposite side of the substrate to the first multilayer film, the second multilayer film being birefringent for light of wavelength λ propagating along the axis that intersects the first layer and the multilayer film. The structures of the first and second multilayer films may be identical.

The first layer may be supported by the multilayer film.

The multilayer film may be supported by the first layer.

A second layer may be disposed between the first layer and the multilayer film.

Rows of the first layer may define a first plane and the layers of the multilayer film may each define a respective plane parallel to and offset from the first plane.

The multilayer film may include alternating layers formed of second and third materials. At least one of the second and third materials may be a nanolaminate material. The first material and at least one of the second and third materials may be materials independently selected from a group consisting of SiO₂, SiNₓ, Si, Al₂O₃, ZrO₂, Ta₂O₅, TiO₂, HfO₂, Nb₂O₅, and MgF₂.

The first layer may further include rows of a second material alternating with the spaced-apart rows of the first material. The second material may define a substrate, the rows of the second material may be defined by walls of trenches within the substrate, and the first material may be disposed within the trenches. The first layer may further include a layer of the first material disposed between the rows of the first layer and the multilayer film.

The multilayer film may include a total of at least about 15 layers of each of second and third different materials. For example, the multilayer film may include a total of at least about 35 layers of each of the second and third materials.

The layers of the multilayer film may each be about 100 nm thick or less.

The article may further include a second layer that includes spaced-apart rows of a second material, and the second layer may be independently birefringent for light of a wavelength λ propagating along an axis that intersects the first and second layers and the multilayer film. The rows of the first material may extend along a first direction and the rows of the second layer may extend along a second direction non-parallel with the first direction. The first and second layers may be disposed on a common side of the multilayer film. Alternatively, the first and second layers may be disposed on opposite sides of the multilayer film. An angle between the first and second directions may be about 80° or less. For example, the angle may be about 70° or less. The angle between the first and second directions may be about 10° or more. For example, the angle may be about 20° or more. The first and second layers together may retard incident radiation at wavelengths λ₁ and λ₂ by respective amounts Γ₁ and Γ₂, where |λ₁−λ₂| may be at least about 15 nm, Γ₁ and Γ₂ may be substantially equal, and both λ₁ and λ₂ may be in a range from about 150 nm to about 5,000 nm. For example, |λ₁−λ₂| may be at least about 30 nm, such as at least about 75 nm, or at least about 100 nm, or at least about 200 nm. The retardation difference expressed by |Γ₁−Γ₂| may be about 0.03π or less, such as about 0.02π or less, or about 0.01π or less. The article may further include an antireflection film disposed between the multilayer film and the first and second layers. A combined thickness of the first and second layers and the multilayer film may be about 10 microns or less. A total thickness of the multilayer film may be about 2 microns or less.

The multilayer film may include a plurality of layers where alternating layers have different refractive indexes at λ and each of the plurality of layers in the multilayer film has a thickness in a range from about 2 nm to about 500 nm.

In another aspect, the invention features an optical retarder for light having a wavelength of about 5,000 nm or less, the optical retarder including a form birefringent a-plate for radiation at a wavelength λ, and a form birefringent c-plate for radiation at λ, where λ is about 5,000 nm or less.

Embodiments of the optical retarder may include one or more of the following features and/or features of other aspects.

In another aspect, the invention features a method that includes using atomic layer deposition to deposit a multilayer film on a surface of a substrate, where the multilayer film is a form birefringent c-plate for light having a wavelength λ and λ is in a range from about 150 nm to about 5,000 nm.

Embodiments of the method may include one or more of the following features and/or features of other aspects. The substrate may include a form birefringent a-plate, where the a-plate is birefringent for light having wavelength λ.

The method may further include forming a form birefringent a-plate on the multilayer film, where the a-plate is birefringent for light of wavelength λ.

Embodiments of the articles may include one or more of the following advantages. For example, embodiments may includes optical retarders that are formed entirely from non-organic materials (e.g., non-organic dielectric materials). Non-organic optical retarders may be more durable than optical retarders that include organic materials, such as organic polymers. For example, non-organic materials are less susceptible to degradation when exposed to radiation for extended periods (e.g., to intense and/or high energy radiation, such as ultraviolet radiation). As a result, applications that utilize the optical retarders may display better long term performance than applications that utilize organic optical retarders. As an example, one application that typically uses an optical retarder is a light modulators (e.g., liquid crystal displays) in a projection display system. Moreover, such light modulators are typically exposed to intense broadband optical radiation for prolonged periods (e.g., about 10,000 hours over the lifetime of the system). Where non-organic retarders are used in such a projection system, the system can exhibit more consistent performance over its lifetime than a system using an organic retarder.

Non-organic optical retarders may also be less susceptible to environmental hazards than comparable retarders that include organic materials. For example, many organic polymeric materials are susceptible to moisture and/or organic solvents, while certain dielectric non-organic materials are not. Accordingly, optical retarders formed exclusively from non-organic materials may be less susceptible to moisture and/or organic solvents than optical retarders formed from organic materials.

In embodiments, optical retarders can be used in high energy regions of the electromagnetic spectrum. For example, due to the high stability of the materials when exposed to high energy radiation, and their versatility of the manufacturing process, optical retarders can be made for operation in the ultraviolet portion of the spectrum (e.g., from about 150 nm to about 400 nm). As an example, optical retarders can be made for use in photolithography tools which utilize radiation at, e.g., about 193 nm.

Optical retarders can include exclusively monolithic form birefringent layers (e.g., layers with optical but not physical nanostructure). Monolithic layers may be more mechanically robust than physically structured layers, and hence less susceptible to defects that adversely impact their optical performance, such as scratches.

Embodiments include optical retarders that are operative over extended wavelength ranges (e.g., about 100 nm or more, about 200 nm or more, about 300 nm or more, about 400 nm or more). For example, some optical retarders may be operative over substantially the entire visible portion of the electromagnetic spectrum. In some embodiments, optical retarders can have a substantially constant retardation across the extended wavelength range (e.g., about quarter wave retardation across the extended wavelength range).

Embodiments of optical retarders may be designed and fabricated for operation at one or more wavelengths within a broad wavelength range. In particular, the versatility of the manufacturing processes used to fabricate the optical retarders in addition to the number of structural parameters of the optical retarders that can be varied allow structures to be optimized for a wavelength or wavelength band in the ultraviolet, visible, or infrared portion of the electromagnetic spectrum. For example, the thickness, grating period, and grating duty cycle of a form-birefringent a-plate retardation layer can be easily varied in the fabrication process, providing substantial flexibility for forming optical retarders with specific birefringence and/or retardation at a chosen wavelength of operation. Furthermore, a variety of different materials can be used to form optical retarders, including nanolaminate materials, which allows substantially flexibility in the refractive index of different portions (e.g., rows or layers) of optical retarders.

Structures with relatively low mechanical stress can also be formed. For example, form birefringent c-plate retardation films can be formed on opposing sides of a substrate, rather than on a single side, providing a more symmetric structure that has lower mechanical stress than an optical retarder with comparable optical properties where the c-plate retardation film is formed on one side of the substrate. Layers can be simultaneously deposited on opposing sides of a substrate using, for example, atomic layer deposition.

Optical retarders may be relatively thin compared to other types of optical retarders with comparable optical properties (e.g., polymer or crystalline optical retarders). For example, the birefringent retardation layers in an optical retarder can have a total thickness of about 10 microns or less (e.g., about five microns or less, about two microns or less).

Optical retardation layers can be readily integrated with other components in an optical system. For example, form-birefringent retardation layers can be formed on substrates that are subsequently integrated into, for example, a liquid crystal display or a laser. As a result, the optical retarders can be used in optical devices with relatively small form factors.

Optical retarders may be zero-order optical retarders. Zero-order optical retarders can have larger ranges of incident operating angles and/or reduce wavelength sensitivity relative to non-zero-order optical retarders.

Optical retarders can exhibit relatively small optical changes as a function of temperature over an operating temperature range. For example, optical retarders can be formed from material pairings that have complementary thermal properties. In other words, material pairings can be selected so that variations in the optical properties of one material due to temperature changes can be offset by the variations in the optical properties of the other material.

The details of one or more embodiments are set forth in the accompanying drawings and the description below. Other features and advantages will be apparent from the description and drawings, and from the claims.

### DESCRIPTION OF DRAWINGS

FIG. 1A is a cross-sectional view of an embodiment of an optical retarder.

FIG. 1B is a perspective view of retardation layers in the optical retarder shown in FIG. 1A.

FIG. 2A is a plan view of a retardation layer in the optical retarder shown in FIG. 1A.

FIG. 2B is a plan view of a second retardation layer in the optical retarder shown in FIG. 1A.

FIG. 3 is a cross-sectional view of another embodiment of an optical retarder.

FIG. 4 is a cross-sectional view of a further embodiment of an optical retarder.

FIG. 5 is a cross-sectional view of an embodiment of a retardation film with its c axis oriented parallel to the z-axis.

FIG. 6 is a cross-sectional view of another embodiment of an optical retarder.

FIG. 7A is a cross-sectional view of a further embodiment of an optical retarder.

FIG. 7B is a cross-sectional view of another embodiment of an optical retarder.

FIG. 8A-8J are schematic diagrams showing various steps in a process for fabricating retardation layers in an optical retarder.

FIG. 9 is a schematic view of an apparatus for atomic layer deposition.

FIG. 10 is a flow chart showing steps in an implementation of atomic layer deposition.

FIG. 11 is a cross-sectional view of an embodiment of a circular polarizer that includes an optical retarder.

FIG. 12 is a schematic diagram of an embodiment of an optical pickup that includes an optical retarder.

FIG. 13 is a cross-sectional schematic diagram of an embodiment of a liquid crystal display that includes a pair of optical retarders.

Like reference symbols in the various drawings indicate like elements.

### DETAILED DESCRIPTION

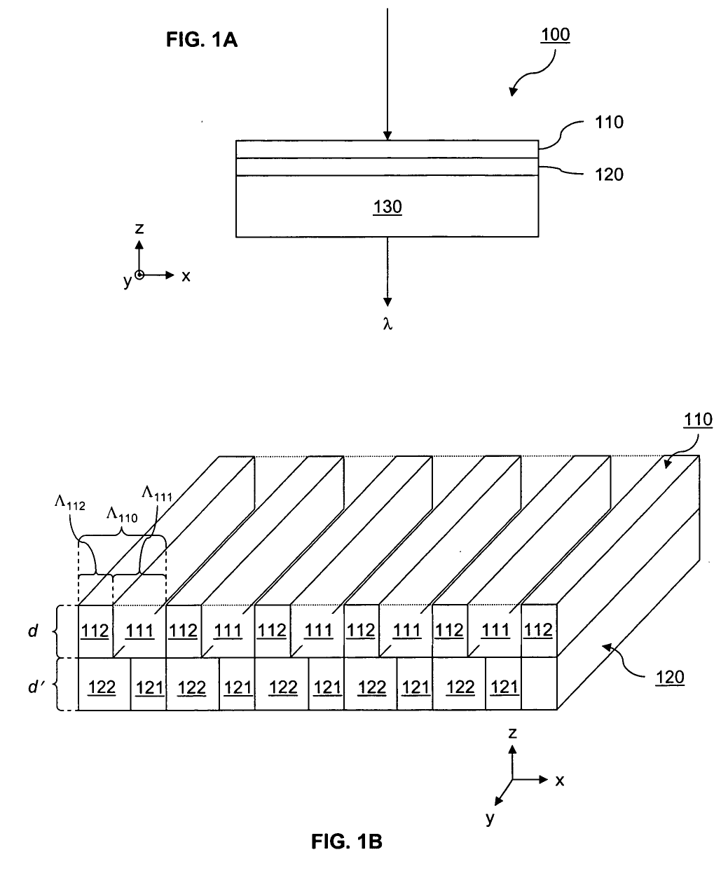

Referring to FIG. 1A, an optical retarder 100 includes a first retardation layer 110 and a second retardation layer 120. Both retardation layers 110 and 120 are birefringent for incident radiation at a wavelength λ. In general, λ can be in the ultraviolet (e.g., from about 100 nm to about 400 nm), optical (e.g., from about 400 nm to about 700 nm), or infrared portions (e.g., from about 700 nm to about 20,000 nm) of the electromagnetic spectrum. A substrate 130 supports first and second retardation layers 110 and 120. A Cartesian co-ordinate system is provided for reference and optical retarder 100 extends in the x-y plane.

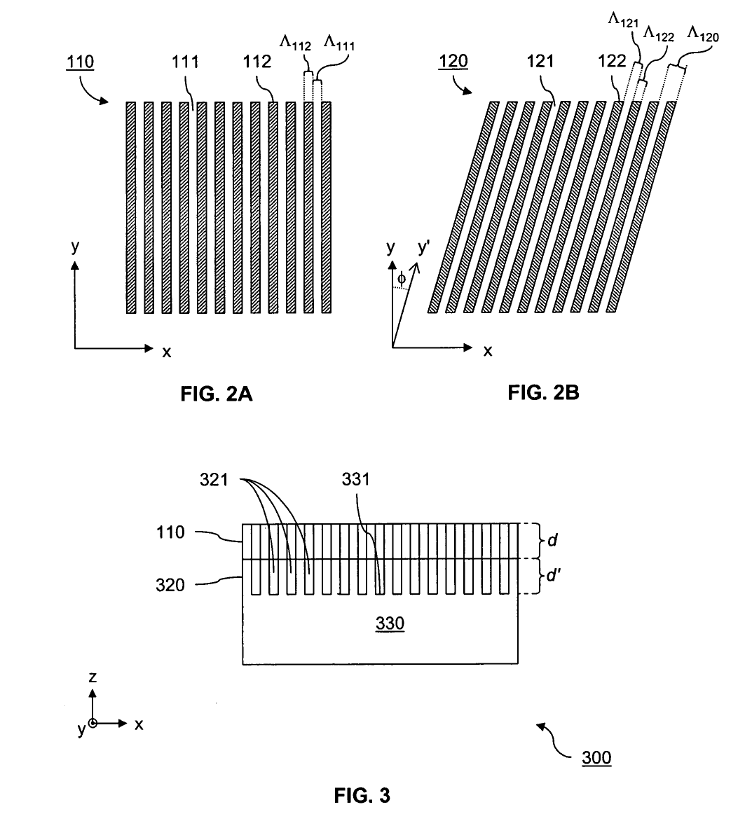

Referring also to FIG. 1B, FIG. 2A, and FIG. 2B, first retardation layer 110 includes a series of spaced-apart rows 111 of a first material separated by a series of spaced-apart rows 112 of a material different from the first material. Rows 111 and 112 both extend substantially parallel to the y-direction. Second retardation layer 120 also includes a series of spaced-apart rows 121 of a second material separated by a spaced apart-rows 122 of a material different from the second material. Rows 121 and 122 both extend along a direction at an angle φ with respect to the y-direction, and form a grating that is periodic in a direction that is at angle φ with respect to the x-direction.

Rows 111 and 112 have widths Λ₁₁₁ and Λ₁₁₂ in the x-direction, respectively. Rows 111 and 112 form a periodic grating in layer 110. The grating in layer 110 has a grating period Λ₁₁₀, which is equal to Λ₁₁₁+Λ₁₁₂. Similarly, rows 121 and 122 have widths Λ₁₂₁ and Λ₁₂₂, respectively, forming a periodic grating in layer 120. The grating in layer 120 has a period Λ₁₂₀, which is equal to Λ₁₂₁+Λ₁₂₂. Layer 100 and layer 120 have thicknesses d and d′ in the z-direction, respectively.

Layers 110 and 120 are form birefringent for radiation having wavelengths greater than Λ₁₁₀. In other words, even though the materials composing layers 110 and 120 are optically isotropic at λ, the structure of the layers (e.g., the alternating spaced-apart rows) result in each layer being birefringent for radiation at λ. Accordingly, different polarization states of radiation having wavelength λ propagate through layers 110 and 120 with different phase shifts. For each layer, the phase shift between the orthogonal polarization states depend on the thickness of the respective layer (e.g., d for layer 110 and d′ for layer 120), the index of refraction at λ of each portion in the layer, the grating period in each layer and the grating's duty cycle. Accordingly, for each layer, these parameters can be selected to provide a desired amount of retardation of optical retarder 100 to polarized light at a wavelength λ.

Each retardation layer can be thought of as an effective uniaxial optical material having a birefringence, Δn(λ), at wavelength λ, which corresponds to |nₑ−nₒ|, where nₑ and nₒ are the effective extraordinary and effective ordinary indexes of refraction, respectively, for that retardation layer. The effective extraordinary axis corresponds to the refractive index of the layer for radiation polarized parallel to the optical axis of the effective uniaxial optical material. In retardation layer 110, for example, the optical axis of the layer is parallel to the y-axis. Accordingly, for this layer, the effective ordinary index of refraction is the index of refraction experienced by radiation having its electric field polarized parallel to the x-axis, while the effective extraordinary index is the index of refraction experienced by radiation having its electric polarized parallel to the y-axis. In retardation layer 120, the optical axis is at an angle φ with respect to the y-axis, parallel to portions 121 and 122. Retardation layers 110 and 120 are examples of so called a-plates, having their optical axes in the plane of the respective layers, the x-y plane.

In general, the values of nₑ and nₒ depend on the indexes of refraction of the portions in each layer, the width of each portion in the layer, and on the radiation wavelength, λ. Without wishing to be bound by theory, the ordinary and extraordinary index for each retardation layer can be determined according to the equations:

$$\begin{matrix}{n}_{o}^{2} = \frac{α}{α + β} {n}_{1}^{2} + \frac{β}{α + β} {n}_{2}^{2} & ( 1 a ) \\ \frac{1}{{n}_{e}^{2}} = \frac{α}{α + β} \frac{1}{{n}_{1}^{2}} + \frac{β}{α + β} \frac{1}{{n}_{2}^{2}} & ( 1 b )\end{matrix}$$

where α and β respectively correspond to Λ₁₁₁ and Λ₁₁₂ for layer 110 and to Λ₁₂₁ and Λ₁₂₂ for layer 120. n₁ and n₂ correspond to n₁₁₁ and n₁₁₂, respectively, for layer 110 and to n₁₂₁ and n₁₂₂, respectively, for layer 120.

In some embodiments, Δn₁₁₀ and/or Δn₁₂₀ are relatively large (e.g., about 0.1 or more, about 0.15 or more, about 0.2 or more, about 0.3 or more, about 0.4 or more, about 0.5 or more, about 0.6 or more, about 0.7 or more, about 0.8 or more, about 0.9 or more, about 1.0 or more). A relatively large birefringence can be desirable in embodiments where a high retardation and/or phase retardation are desired (see below), or where a relatively thin retardation layer is desired. In certain embodiments, Δn₁₁₀ and/or Δn₁₂₀ are relatively small (e.g., about 0.05 or less, about 0.04 or less, about 0.03 or less, about 0.02 or less, about 0.01 or less, about 0.005 or less, about 0.002 or less, 0.001 or less). A relatively small birefringence may be desirable in embodiments where a low retardation or phase retardation are desired, and/or where relatively low sensitivity of the retardation and/or phase retardation to variations in the thickness of retardation layer 110 is desired. Δn₁₁₀ and/or Δn₁₂₀ can also be between about 0.05 and about 0.1 (e.g., about 0.06, about 0.07, about 0.08, about 0.09).

In general, the ratio of Δn₁₁₀ to Δn₁₂₀ can vary. In some embodiments, Δn₁₁₀ is approximately equal to Δn₁₂₀. For example, the ratio Δn₁₁₀/Δn₁₂₀ can be in a range from about 0.5 to about two (e.g., about 0.75 to about 1.5, such as about one). In certain embodiments, however, Δn₁₁₀ can be relatively large, while Δn₁₂₀ can be relatively small. For example, the ratio Δn₁₁₀/Δn₁₂₀ can be more than about two (e.g., about three or more, about four or more, about five or more, about six or more, about eight or more, about 10 or more). Alternatively, Δn₁₂₀ can be relatively small, while Δn₁₂₀ is relatively large. For example, the ratio Δn₁₁₀/Δn₁₂₀ can be less than about 0.5 (e.g., about 0.4 or less, about 0.3 or less, about 0.2 or less, about 0.1 or less, about 0.05 or less).

The retardation of each retardation layer at λ is the product of the layer's thickness and its birefringence at λ. By selecting appropriate values for Δn₁₁₀ and the d and/or Δn₁₂₀ and d′ the retardation of layers 110 and 120, respectively, can vary as desired. In some embodiments, the retardation of retardation layers 110 and/or layer 120 is about 50 nm or more (e.g., about 75 nm or more, about 100 nm or more, about 125 nm or more, about 150 nm or more, about 200 nm or more, about 250 nm or more, about 300 nm or more, about 400 nm or more, about 500 nm or more, about 1,000 or more, such as about 2,000 nm). In certain embodiments, the retardation of layers 110 and/or 120 is about 40 nm or less (e.g., about 30 nm or less, about 20 nm or less, about 10 nm or less, about 5 nm or less, about 2 nm or less).

In general, the relative retardation of layers 110 and 120 can vary. In some embodiments, the retardation of layer 110 can be about the same as the retardation of layer 120 at λ. For example, the ratio [Δn₁₁₀(λ)d]/[Δn₁₂₀(λ)d′] can in a range from about 0.5 to about 1.5 (e.g., from about 0.75 to about 1.25, such as about one). However, in certain embodiments, the retardation of layer 110 can be relatively large compared to the retardation of layer 120. For example, the ratio Δn₁₁₀(λ)d/Δn₁₂₀(λ)d′ can be more than about 1.5 (e.g., about three or more, about four or more, about five or more, about six or more, about eight or more, about 10 or more). Alternatively, the retardation of layer 110 can be relatively small compared to the retardation of layer 120. For example. the ratio Δn₁₁₀(λ)d/Δn₁₂₀(λ)d′ can be less than about 0.5 (e.g., about 0.4 or less, about 0.3 or less, about 0.2 or less, about 0.1 or less, about 0.05 or less).

In some embodiments, the retardation of layer 110 and/or layer 120 corresponds to λ/4 or λ/2.

Retardation layers 110 and 120 also have respective phase retardations, Γ₁₁₀ and Γ₁₂₀, at wavelength λ, which can be determined according to the equation:

$${Γ}_{110 / 120} ( λ ) = \frac{2 π}{λ} \cdot Δ {n}_{110 / 120} ( λ ) \cdot D , \qquad ( 2 )$$

where D is d for layer 110 and d′ for layer 120.

Quarter wave phase retardation is given, for example, by Γ=π/2, while half wave phase retardation is given by Γ=π. In general, phase retardation for a layer may vary as desired, and is generally selected based on the desired end use application of optical retarder 100. In some embodiments, phase retardation for layers 110 and/or 120 may be about 2π or less (e.g., about π or less, about 0.8π or less, about 0.7π or less, about 0.6π or less, about 0.5π or less, about 0.4π or less, about 0.2π or less, 0.2π or less, about 0.1π or less, about 0.05π or less, 0.01π or less). In certain embodiments, phase retardation of retardation layers 110 and/or 120 can be more than 2π r(e.g., about 3π or more, about 4π or more, about 5π or more).

In some embodiments, one of the retardation layers 110 and 120 has half-wave retardation at λ, while the other retardation layer has quarter-wave retardation at λ.

In general, the dispersion of retardation layer 110 can be the same or different as the dispersion of retardation 120. Dispersion of a layer refers to the dependence of nₑ and nₒ on wavelength. The dispersion of each retardation layer depends on the dispersion of the materials used to form the layers (i.e., the materials used to form rows 111 and 112 in layer 110, and the materials used to form 121 and 122 in layer 120) and on the dimensions of the structures forming the layers.

In general, the dispersion of an optical retarder can be measured using methods known in the art. For example, a Mueller Matrix SpectroPolarimeter (e.g., from Axometrics Inc., 515 Sparkman Dr., Huntsville, Ala., 35816) that includes an arc lamp light source and a scanning monochromator can be used to measure a complete set of polarization properties for a selected sample in a spectral range from about 450 nm to about 800 nm. The dispersion or retardance for an optical retarder can, for example, be measured for any wavelength in the above range, yielding a retardance dispersion curve for the retarder. Alternatively, or additionally, the dispersion or retardance for each material used in the optical retarder can separately be measured for any wavelength in the above range to yield separate retardance dispersion curves for each of the materials. The retardance dispersion curves for the materials can then be used, together with knowledge of the structural parameters of the optical retarder, to calculate the optical retarder's dispersion according to effective medium theory, for example. In some cases, both of these methods are used concurrently and the results are compared.

Alternatively, or additionally, dispersion of an optical retarder and/or retardation layer can be determined using theoretical models to calculate the birefringence of the optical retarder and/or retardation layer at different wavelengths. For such calculations, the values of the optical constants of the materials at different wavelengths can be found, for example, in the Handbook of Optical Constants of Solids, 1st edition, edited by Edward D. Palik, Academic Press, (1997).

Widths Λ₁₁₁, Λ₁₁₂, Λ₁₂₁, and Λ₁₂₂ and grating periods Λ₁₁₀ and Λ₁₂₀ and duty cycles are selected based on the desired optical characteristics of retardation layers 110 and 120, respectively. Typically, periods Λ₁₁₀ and Λ₁₂₀ are less than λ, so that retardation layers 110 and 120 are form birefringent for radiation at λ. For example, Λ₁₁₀ and/or Λ₁₂₀ can be about 0.8λ or less (e.g., about 0.6λ or less, about 0.5λ or less, about 0.4λ or less, about 0.3λ or less, about 0.2λ or less, about 0.1λ or less).

In some embodiments, Λ₁₁₀ and/or Λ₁₂₀ is in a range from about 20 nm to about 500 nm. For example, where optical retarder 100 is designed to operate in the visible and/or ultraviolet portions of the electromagnetic spectrum, Λ₁₁₀ and/or Λ₁₂₀ may be in this range. Λ₁₂₀, can be, for example, about 40 nm or more (e.g., about 50 nm or more, about 75 nm or more, about 100 nm or more, about 125 nm or more, about 150 nm or more, about 175 nm or more, about 200 nm or more). Λ₁₁₀ and/or Λ₁₂₀ can be about 450 nm or less (e.g., about 425 nm or less, about 400 nm or less, about 375 nm or less, about 350 nm or less, about 325 nm or less, about 300 nm or less, about 275 nm or less, about 250 nm or less, about 225 nm or less). In certain embodiments, Λ₁₁₀ and/or Λ₁₂₀ can larger than 500 nm. Λ₁₁₀ and/or Λ₁₂₀ can be in a range from about 600 nm to about 2,000 nm when, for example, optical retarder is designed to operate in the infrared portion of electromagnetic spectrum. For example, Λ₁₁₀ and/or Λ₁₂₀ can be about 800 nm or more (e.g., about 1,000 nm or more, about 1,100 nm or more, about 1,200 nm or more). Λ₁₁₀ and/or Λ₁₂₀ can be about 1,800 nm or less (e.g., about 1,600 nm or less, about 1,500 nm or less, about 1,400 nm or less, about 1,300 nm or less, about 1,200 nm or less).

The period of the grating in layer 120, Λ₁₂₀, can be the same or different as the period of the grating in layer 110, Λ₁₁₀. In certain embodiments, Λ₁₂₀ is approximately equal to Λ₁₁₀. For example, the ratio Λ₁₂₀/Λ₁₁₀ can be in a range from about 0.9 to about 1.1 (e.g., from about 0.95 to about 1.05, such as about one). In some embodiments, Λ₁₂₀ is larger than Λ₁₁₀. For example, Λ₁₂₀/Λ₁₁₀ can be about 1.1 or more (e.g., about 1.2 or more, about 1.3 or more, about 1.4 or more, about 1.5 or more, about 1.8 or more, about two or more). Alternatively, in certain embodiments, Λ₁₂₀ is smaller than Λ₁₁₀. For example, Λ₁₂₀/Λ₁₁₀ can be less than about 0.9 (e.g., about 0.8 or less, about 0.7 or less, about 0.6 or less, about 0.5 or less, about 0.4 or less, about 0.3 or less, about 0.2 or less, about 0.1 or less).

The grating in layers 110 and 120 have duty cycles Λ₁₁₂/Λ₁₁₀ and Λ₁₂₂/Λ₁₂₀, respectively. In general, the duty cycle of the grating in layers 110 and 120 may vary as desired. In some embodiments, the duty cycles of the gratings in layers 110 and/or 120 are in a range from about 0.2 to about 0.8 (e.g., about 0.3 or more, about 0.4 or more, about 0.5 or more, or about 0.7 or less, about 0.6 or less).

The duty cycle of the grating in layer 120 can be the same or different as the duty cycle of the grating in layer 110. For example, the ratio of the duty cycle of the grating in layer 110 can be about 0.1 or more (e.g., about 0.2 or more, about 0.3 or more, about 0.4 or more, about 0.5 or more, about 0.6 or more, about 0.7 or more, about 0.8 or more, about 0.9 or more, about one or more, about 1.1 or more, about 1.2 or more, about 1.3 or more, about 1.4 or more, about 1.5 or more, about 1.8 or more, about two or more, about three or more, about four or more, about five or more, about six or more, about eight or more, about 10 or more) times the duty cycle of the grating in layer 120.

In general, thickness d can be the same or different as thickness d′ d and/or d′ can be less than or greater than λ. For example, d and/or d′ can be about 0.1 λ or more (e.g., about 0.2 λ or more, about 0.3 λ or more, about 0.5 λ or more, about 0.8 λ or more, about λ or more, about 1.5 λ or more, such as about 2 λ or more). In certain embodiments, d can be about 50 nm or more (e.g., about 75 nm or more, about 100 nm or more, about 125 nm or more, about 150 nm or more, about 200 nm or more, about 250 nm or more, about 300 nm or more, about 400 nm or more, about 500 nm or more, about 750 nm or more, such as about 1,000 nm). In some embodiments, d′ can be about 50 nm or more (e.g., about 75 nm or more, about 100 nm or more, about 125 nm or more, about 150 nm or more, about 200 nm or more, about 250 nm or more, about 300 nm or more, about 400 nm or more, about 500 nm or more, about 750 nm or more, such as about 1,000 nm).

In general, the relative thickness of layer 120 to layer 110 can vary as desired. In some embodiments, layers 110 and 120 have approximately the same thickness. For example, d/d′ can be in a range from about 0.5 to about 1.5 (e.g., from about 0.75 to about 1.25, such as about one). In certain embodiments, layer 110 is notably thicker than layer 120. For example, d/d′ can greater than about 1.5 (e.g., about 1.75 or more, about two or more, about three or more, about four or more, about five or more, about eight or more, about 10 or more). Alternatively, in some embodiments, layer 110 is notably thinner than layer 120. For example, d/d′ can be less than about 0.5 (e.g., about 0.4 or less, about 0.3 or less, about 0.2 or less, about 0.1 or less).

In some embodiments, the combined thickness of retardation layers 110 and 120 can vary as desired. Generally, the combined thickness of the retardation layers refers to the thickness of the retardation layers along the z-axis from the lower surface of the lowest retardation layer to the upper surface of the top-most retardation layer. For optical retarder 100, the combined thickness of the retardation layers is equal to d+d′. In certain embodiments, the combined thickness of the retardation layers in an optical retarder can be relatively small. For example, the combined thickness can be about five microns or less (e.g., about four microns or less, about three microns or less, about two microns or less, about one micron or less, about 0.5 microns or less). A relatively small combined thickness may be advantageous because it can provide optical retarders with relatively compact form factors.

The aspect ratio of retardation layer gratings can be relatively high. Aspect ratio refers to the thickness of the respective layer (e.g., d for retardation layer 110 and d′ for layer 120) to the width of one of the portions in the layer (e.g., Λ₁₁₁ in retardation layer 110 and Λ₁₂₁ in retardation layer 120). For example, d:Λ₁₁₁ and/or d′:Λ₁₂₁ can be about 2:1 or more (e.g., about 3:1 or more, about 4:1 or more, about 5:1 or more, about 8:1 or more, about 10:1 or more).

Relative orientation angle φ may vary. φ is typically selected based on the desired optical characteristics of optical retarder 100. φ can be determined using theoretical models (see discussion infra) and/or by empirical studies. In certain embodiments, φ is relatively small. For example, φ can be about 20° or less (e.g., about 18° or less, about 15° or less, about 12° or less, about 10° or less, about 8° or less, about 6° or less, about 5° or less, about 4° or less, about 3° or less, about 2° or less). Alternatively, in some embodiments, f can be larger than 20°. For example, φ can be about 25° or more, about 30° or more, about 35° or more, about 40° or more, about 45° or more, about 50° or more, about 55° or more, about 60° or more, about 65° or more, about 70° or more, about 75° or more). In certain embodiments, the rows in retardation layer 120 can be close to perpendicular to the rows in retardation layer 110. For example, φ can be about 80° or more (e.g., about 85° or more, such as about 90°).

In embodiments, the orientation angle φ, is selected based on the retardation of retardation layers 110 and 120 at one or more wavelengths so that the retardation of optical retarder at those wavelengths is at or close to a desired value. For example, in some embodiments, φ, Γ₁₁₀ and Γ₁₂₀ can be selected so that optical retarder 100 has a retardation Γ₁₀₀, that is substantially equal at two different wavelengths, λ₁ and λ₂.

In other words, at λ₁, optical retarder 100 has a phase retardation Γ₁, while at λ₂, optical retarder 100 has a phase retardation Γ₂, where Γ₁˜Γ₂. For example, in some embodiments, |Γ₁−Γ₂| is about 0.057π or less, about 0.03π or less, about 0.02π or less, about 0.01π or less, about 0.005π or less, 0.001π or less. In certain embodiments, Γ₁ and Γ₂ vary by about 10% or less (e.g., about 8% or less, about 5% or less, about 4% or less, about 3% or less, about 2% or less, about 1% or less).

Moreover, values of Γ₁₀₀ for wavelengths in a range of wavelengths Δλ are substantially constant. For example, Γ₁₀₀ for any wavelength λ′ in the range Δλ can vary from Γ₁ by about 0.05π or less, about 0.03π or less, about 0.02π or less, about 0.01π or less, about 0.005π or less, 0.001π or less. In some embodiments, Γ varies by about 10% or less over the range Δλ (e.g., by about 8% or less, by about 5% or less, by about 4% or less, by about 3% or less, by about 2% or less, by about 1% or less) for a range of wavelengths that is about 20 nm or more (e.g., about 30 nm or more, about 40 nm or more, about 50 nm or more, about 60 nm or more, about 70 nm or more, about 100 nm or more, about 200 nm or more, about 300 nm or more, about 500 nm or more, about 1,000 nm or more). Optical retarders where Γ₁₀₀ is substantially constant over a relatively large range of wavelengths (e.g., about 100 nm or more) is referred to as an achromatic retarder.

The location of Δλ in the electromagnetic spectrum can be designated by a central wavelength, λ_{c}, which is given by ½(λ₁+λ₂). In general, λ_{c} can vary as desired, and is typically selected based on the end use application of optical retarder 100. For example, in telecommunication applications that use infrared radiation, λ_{c} can be between about 800 nm and about 2,000 nm (e.g., between about 900 nm and about 1,000 nm, or from about 1,300 nm and about 1,600 nm). As another example, where optical retarder 100 is used in an optical memory device (e.g., a compact disc (CD) or digital versatile disc (DVD) device), λ_{c} can be in the visible portion or near-infrared portion of the electromagnetic spectrum (e.g., from about 400 nm to about 850 nm). As another example, where optical retarder 100 is used as a component in a lithography exposure apparatus, λ_{c} is typically in the ultraviolet portion of the spectrum (e.g., from about 150 nm to about 400 nm).

Various metrics can be used to characterize the phase retardation spectrum of an optical retarder, including, for example, the spectral flatness and integrated spectral flatness of the spectrum, and the dispersion slope of the phase retardation spectrum.

Spectral flatness, Δ, of a retarder is given by:

$$Δ = 2 \cdot [ \frac{Γ ( {λ}_{1} ) - Γ ( {λ}_{2} )}{Γ ( {λ}_{1} ) + Γ ( {λ}_{2} )} ] \times 100 \% , \qquad ( 4 )$$

and is related to the variation of a retarder's phase retardation at λ₁ and λ₂. In some embodiments, Δ can be relatively small. For example, Δ can be about 10% or less (e.g., about 8% or less, about 5% or less, about 3% or less, about 2% or less) for |λ₁−λ₂| of about 20 nm or more (e.g., about 50 nm or more, about 100 nm or more, about 200 nm or more).

Integrated spectral flatness, σ, is given by

$$\begin{matrix}σ = {\{ \frac{1}{{λ}_{2} - {λ}_{1}} {\int }_{{λ}_{1}}^{{λ}_{2}} {[ Γ ( λ ) / \overline{Γ} - 1 ]}^{2} ⅆ λ \}}^{1 / 2} \\ where & ( 5 ) \\ \overline{Γ} = \frac{1}{{λ}_{2} - {λ}_{1}} {\int }_{{λ}_{1}}^{{λ}_{2}} Γ ( λ ) \cdot ⅆ λ . & ( 6 )\end{matrix}$$

Integrated spectral flatness is related to the variation of an optical retarder's phase retardation over the range of wavelengths from λ₁ to λ₂. In certain embodiments, σ can be relatively small. For example, σ can be about 10% or less (e.g., about 8% or less, about 5% or less, about 3% or less, about 2% or less) for |λ₁−λ₂| of about 20 nm or more (e.g., about 50 nm or more, about 100 nm or more, about 200 nm or more).

Another parameter that can be used to characterize an optical retarder from its phase retardation spectrum is the dispersion slope, k_{D}, which is related to a linear component of the retarder's phase retardation spectrum over a spectral range defined by λ₁ and λ₂. k_{D} can be determined as a fit parameter B for a minimum value of ε given by the equation

$$\begin{matrix}ɛ ( B , C ; {λ}_{c} ) = {[ \frac{1}{{λ}_{2} - {λ}_{1}} {\int }_{{λ}_{1}}^{{λ}_{2}} {( \frac{Γ ( λ )}{Γ ( {λ}_{c} )} - B \cdot \frac{{λ}_{c}}{λ} - C )}^{2} ⅆ λ ]}^{\frac{1}{2}} , \\ where & ( 7 ) \\ {λ}_{c} = \frac{{λ}_{1} + {λ}_{2}}{2} & ( 8 )\end{matrix}$$

and C is another fitting parameter. A small value of k_{D} can be indicative of a high degree of achromaticity in the retarder's performance over the spectral range from λ₁ to λ₂.

The linearity of an optical retarder's phase retardation spectrum is related to ε² when ε is minimized. A value of ε² close to unity indicates a substantially linear phase retardation over the range λ₁ to λ₂, while a value of ε² close to zero indicates substantial non-linearity. In some embodiments, ε² can be about 0.8 or more (e.g., about 0.9 or more, about 0.95 or more, about 0.97 or more, about 0.98 or more, about 0.99 or more) for |λ₁−λ₂| of about 20 nm or more (e.g., about 50 nm or more, about 100 nm or more, about 200 nm or more).

In general, the thickness of retardation layer 110 and retardation layer 120, widths Λ₁₁₁, Λ₁₁₂, Λ₁₂₁ and Λ₁₂₂, and the refractive indexes of the materials forming layers 110 and 120, and orientation angle φ are selected to provide desired retardation over wavelength range for one or more wavelengths in the range Δλ. The value for each of these parameters can be determined using computer modeling techniques. For example, in some embodiments, the structure of retardation layers 110 and/or 120 can be determined using a computer-implemented algorithm that varies one or more of the grating parameters until the grating design provides the desired retardation values at the wavelengths of interest. One model that can be used is referred to as “rigorous coupled-wave analysis” (RCWA), which solves the governing Maxwell equations of the gratings. RCWA can be implemented in a number of ways. For example, one may use commercial software, such as GSolver, from Grating Development Company (GDC) (Allen, Tex.), to evaluate and the grating structure for transmissions and reflections. Alternatively, or additionally, RCWA can be implemented to calculate the relative phase shift among different polarization states. One or more optimization techniques such as, for example, direct-binary search (DBS), simulated annealing (SA), constrained global optimization (CGO), simplex/multiplex, may be used in combination with the RCWA to determine the structure of retardation layers 110 and 120 that will provide desired optical performance for each layer and for optical retarder 100. Optimization techniques are described, for example, in Chapter 10 of “Numerical Recipes in C, the Art of Scientific Computing,” by W. H. Press et al., University of Cambridge Press, 2^{nd} Ed. (1992). Examples of implementations of RCWA are described by L. Li in “Multilayer modal method for diffraction gratings of arbitrary profile, depth, and permittivity,” J. Opt. Soc. Am. A, Vol. 10, No. 12, p. 2581 (1993) and by T. K. Gaylord and M. G Moharam in “Analysis and applications of optical diffraction gratings,” Proc. IEEE, Vol. 73, No. 5 (1985).

Alternatively, or additionally, effective media theory (EMT) can be used to determine the approximate phase of radiation at various wavelengths that traverses retardation layers 110 and 120 for different values of parameters associated with the structure of retardation layers 110 and 120. Implementations of EMT are described, for example, by H. Kikuta et al., in “Achromatic quarter-wave plates using the dispersion of form birefringence,” Applied Optics, Vol. 36, No. 7, pp. 1566-1572 (1997), by C. W. Haggans et al., in “Effective-medium theory of zeroth order lamellar gratings in conical mountings,” J. Opt. Soc. Am. A, Vol. 10, pp 2217-2225 (1993), and by H. Kikuta et al., in “Ability and limitations of effective medium theory for subwavelength gratings,” Opt. Rev., Vol. 2, pp. 92-99 (1995).

In general, the materials used to form the spaced-apart rows in each retardation layer can vary. Materials are usually selected based on their refractive index at the wavelength(s) of interest. Typically, the material forming rows 111 will have a different refractive index from the material forming rows 112 at one or more wavelengths of interest. Similarly, the material forming rows 121 will typically have a different refractive index from the material forming rows 122 at one or more wavelengths of interest.

In some embodiments, materials with a relatively high refractive index are used to form one or more of the spaced-apart rows. For example, materials can have a refractive index of about 1.8 or more (e.g., about 1.9 or more, about 2.0 or more, about 2.1 or more, about 2.2 or more, about 2.3 or more). Examples of materials with a relatively high refractive index include TiO₂, which has a refractive index of about 2.35 at 632 nm, or Ta₂O₅, which has a refractive index of 2.15 at 632 nm.

Alternatively, or additionally, rows can be formed from materials with a relatively low refractive index (e.g., about 1.7 or less, about 1.6 or less, about 1.5 or less). Examples of low index materials include MgF₂, SiO₂ and Al₂O₃, which have refractive indexes of about 1.37, 1.45 and 1.65 at 632 nm, respectively. Various polymers can also have relatively low refractive index (e.g., from about 1.4 to about 1.7)

In some embodiments, the material(s) used to form the rows have a relatively low absorption at wavelengths of interest, so that retardation layer 110 and/or retardation layer 120 has a relatively low absorption at those wavelengths. For example, retardation layer 110 and/or retardation layer 120 can absorb about 5% or less (e.g., about 3% or less, about 2% or less, about 1% or less, about 0.5% or less, about 0.2% or less, about 0.1% or less) of incident radiation at wavelengths in the range Δλ propagating parallel to the z-axis.

In general, the materials forming rows 111, 112, 121, and/or 122 can include inorganic and/or organic materials. Examples of inorganic materials include metals, semiconductors, and inorganic dielectric materials (e.g., glass, SiNₓ). Examples of organic materials include organic polymers.

In embodiments, rows 111, 112, 121, and/or 122 are formed from one or more dielectric materials, such as dielectric oxides (e.g., metal oxides), fluorides (e.g., metal fluorides), sulphides, and/or nitrides (e.g., metal nitrides). Examples of oxides include SiO₂, Al₂O₃, Nb₂O₅, TiO₂, ZrO₂, HfO₂, SnO₂, ZnO, ErO₂, Sc₂O₃, and Ta₂O₅. Examples of fluorides include MgF₂. Other examples include ZnS, SiNₓ, SiO_{y}Nₓ, AlN, TiN, and HfN.

Rows 111, 112, 121, and/or 122 can be formed from a single material or from multiple different materials (e.g., composite materials, such as nanocomposite materials).

Rows 111, 112, 121, and/or 122 can include crystalline, semi-crystalline, and/or amorphous portions. Typically, an amorphous material is optically isotropic and may transmit light better than portions that are partially or mostly crystalline. As an example, in some embodiments, rows 111 and 112 are formed from amorphous materials, such as amorphous dielectric materials (e.g., amorphous TiO₂ or SiO₂, respectively). Alternatively, in certain embodiments, rows 111 are formed from a crystalline or semi-crystalline material (e.g., crystalline or semi-crystalline Si), while layers 112 are formed from an amorphous material (e.g., an amorphous dielectric material, such as TiO₂ or SiO₂).

In certain embodiments, the materials used to form rows 111 and 112 are selected so that retardation layer 110 has a certain birefringence at λ. Similarly, in some embodiments, the materials used to form rows 121 and 122 are selected so that retardation layer 120 has a certain birefringence at λ. In general, where a relatively large birefringence for a retardation layer is obtained by using materials in adjacent rows having substantially different refractive indexes. As an example, adjacent rows can be formed using SiO₂ and MgF₂, which have refractive indexes of 1.45 and 1.37 at 632 nm, respectively. Conversely, where a retardation layer having a relatively small birefringence is desired, adjacent rows can be formed using materials having similar refractive indexes. As an example, adjacent rows can be formed using SiO₂ and TiO₂, which has a refractive index of 2.35 at 632 nm. Possible values for birefringence of retardation layers 110 and 120 are presented supra.

Referring now to other layers in optical retarder 100, in general, substrate 130 provides mechanical support to optical retarder 100. In certain embodiments, substrate 130 is transparent to light at wavelength λ₁ and λ₂, transmitting substantially all light impinging thereon at wavelengths λ₁ and λ₂ (e.g., about 90% or more, about 95% or more, about 97% or more, about 99% or more, about 99.5% or more).

In general, substrate 130 can be formed from any material compatible with the manufacturing processes used to produce retarder 100 that can support the other layers. In certain embodiments, substrate 130 is formed from a glass, such as BK7 (available from Abrisa Corporation), borosilicate glass (e.g., pyrex available from Corning), aluminosilicate glass (e.g., C1737 available from Corning), or quartz/fused silica. In some embodiments, substrate 120 can be formed from a crystalline material, such as a non-linear optical crystal (e.g., LiNbO₃ or a magneto-optical rotator, such as garnett) or a crystalline (or semicrystalline) semiconductor (e.g., Si, InP, or GaAs). Substrate 130 can also be formed from an inorganic material, such as a polymer (e.g., a plastic). Substrates can also be a metal or metal-coated substrate.

In some embodiments, one of the retardation layers can be formed in a surface of the substrate. For example, referring to FIG. 3, an optical retarder 300 includes a retardation layer 320, where the form-birefringent structure in the retardation layer is formed in a surface 331 of a substrate 330. In particular, surface 331 includes a number of trenches 321 (three of the trenches are labeled in FIG. 3) filled with a material with a different refractive index from substrate 330. Retardation layer 320 has a thickness in the z-direction of d′, corresponding to the depth of trenches 321. Retardation layer 110 is formed on top of retardation layer 320.

Embodiments of optical retarders can include one or more additional layers. For example, embodiments of optical retarders can include more than two retardation layers (e.g., three retardation layers, four retardation layers, five retardation layers or more). In general, the relative orientation between the rows in each adjacent layer can vary and can be optimized so that the optical retarder provides desired optical characteristics for one or more wavelengths. As an example, an optical retarder can include a retardation layer having half-wave retardation at λ disposed between two quarter-wave retardation layers. The quarter-wave retardation layers include spaced-apart rows extending parallel to the y-axis, while the half-wave layer has rows extending at angle φ with respect to the y-axis. φ is selected so that the three layers function as an achromatic quarter-wave retarder for a range of wavelengths, as described by S. Pancharatnam in “Achromatic Combinations of Birefringent Plates,” Proc. Indian Acad. Sci. 41, pp. 136-144 (1955), for example.

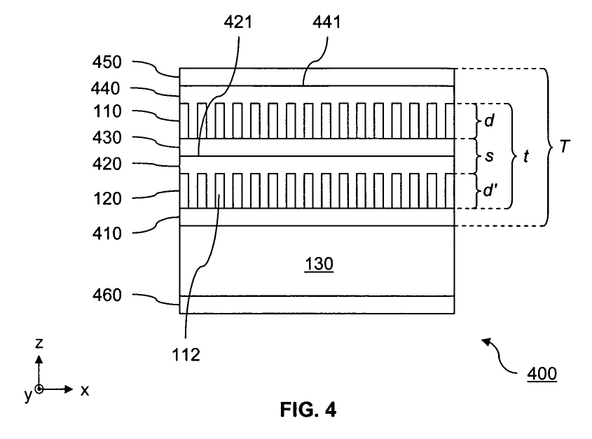

In embodiments, optical retarders can include one or more layers on a substrate in addition to the retardation layers. For example, referring to FIG. 4, in addition first retardation layer 110, second retardation layer 120, and substrate 130, an optical retarder 400 includes an etch stop layer 410, cap layers 420 and 440, and antireflection films 430, 450, and 460.

Etch stop layer 410 is formed from a material resistant to etching processes used to etch the material(s) from which rows 112 are formed (see discussion below). The material(s) forming etch stop layer 410 should also be compatible with substrate 130 and with the materials forming retardation layer 110. Examples of materials that can form etch stop layer 410 include HfO₂, SiO₂, Al₂O₃, Ta₂O₅, TiO₂, SiNₓ, or metals (e.g., Cr, Ti, Ni).

The thickness of etch stop layer 410 in the z-direction can vary as desired. Typically, etch stop layer 410 is sufficiently thick to prevent significant etching of substrate 130, but should not be so thick as to adversely impact the optical performance of optical retarder 400. In some embodiments, etch stop layer is about 500 nm or less thick (e.g., about 250 nm or less, about 100 nm or less, about 75 nm or less, about 50 nm or less, about 40 nm or less, about 30 nm or less, about 20 nm or less).

Cap layers 420 and 440 cover layers 120 and 110, respectively, and provide smooth surfaces 421 and 441 onto which antireflection films 430 and 450 can be respectively deposited. In general, the thickness along the z-direction and composition of cap layers 420 and 440 can vary as desired, and are typically selected so that the layers provide their mechanical function without substantially adversely affecting the optical performance of retarder 400. In some embodiments, cap layer 420 and/or cap layer 440 are about 50 nm or more thick (e.g., about 70 nm or more thick, about 100 nm or more thick, about 150 nm or more thick, about 300 nm or more thick). Cap layers can be formed from dielectric materials, such as dielectric oxides (e.g., metal oxides), fluorides (e.g., metal fluorides), sulphides, and/or nitrides (e.g., metal nitrides), such as those listed above.

In optical retarder 400, retardation layer 110 and retardation layer 120 are separated by a distance s. In general, s can vary, and depends on the thickness layers disposed between the retardation layers (e.g., cap layer 420 and etch stop layer 430 in optical retarder 400). Typically, s is about 10 nm or more (e.g., about 20 nm or more, about 50 nm or more, about 100 nm or more, about 200 nm or more). s can be relatively small (e.g., about 1,000 nm or less, about 800 nm or less, about 600 nm or less, about 500 no or less, about 400 nm or less, about 300 nm or less).

As a result, the combined thickness, t, of retardation layers 110 and 120 in optical retarder 400 can be relatively small (e.g., about 10 microns or less, about eight microns or less, about six microns or less, about five microns or less, about four microns or less, about three microns or less, about two microns or less).

Moreover, the combined thickness, T, of the all the layers on the side of the substrate that the retardation layers are disposed can be relatively small. For example, T can be about 15 microns or less, about 12 microns or less (e.g., about 10 microns or less, about eight microns or less, about six microns or less, about five microns or less, about four microns or less).

Antireflection films 430, 450, and 460 can reduce the reflectance of radiation at one or more wavelengths of interest impinging on and exiting optical retarder 400. Antireflection films generally include one or more layers of different refractive index. As an example, one or more of antireflection films 430, 450, and 460 can be formed from four alternating high and low index layers. The high index layers can be formed from TiO₂ or Ta₂O₅ and the low index layers can be formed from SiO₂ or MgF₂. The antireflection films can be broadband antireflection films or narrowband antireflection films.

In some embodiments, optical retarders, such as optical retarder 400, have a reflectance of about 5% or less of light impinging thereon at wavelength λ₁ and/or λ₂ (e.g., about 3% or less, about 2% or less, about 1% or less, about 0.5% or less, about 0.2% or less). Furthermore, optical retarder 400 can have high transmission of light of wavelength λ₁ and/or λ₂. For example, optical retarder can transmit about 95% or more of light impinging thereon at wavelength λ₁ and/or λ₂ (e.g., about 96% or more, about 97% or more, about 98% or more, about 99% or more, about 99.5% or more).

Moreover, while the gratings forming the retardation layers in the foregoing embodiments have a rectangular profile, in general, the grating can have other profiles. For example, the grating may have a sinusoidal, triangular, trapezoidal (e.g., tapered), or sawtooth profile.

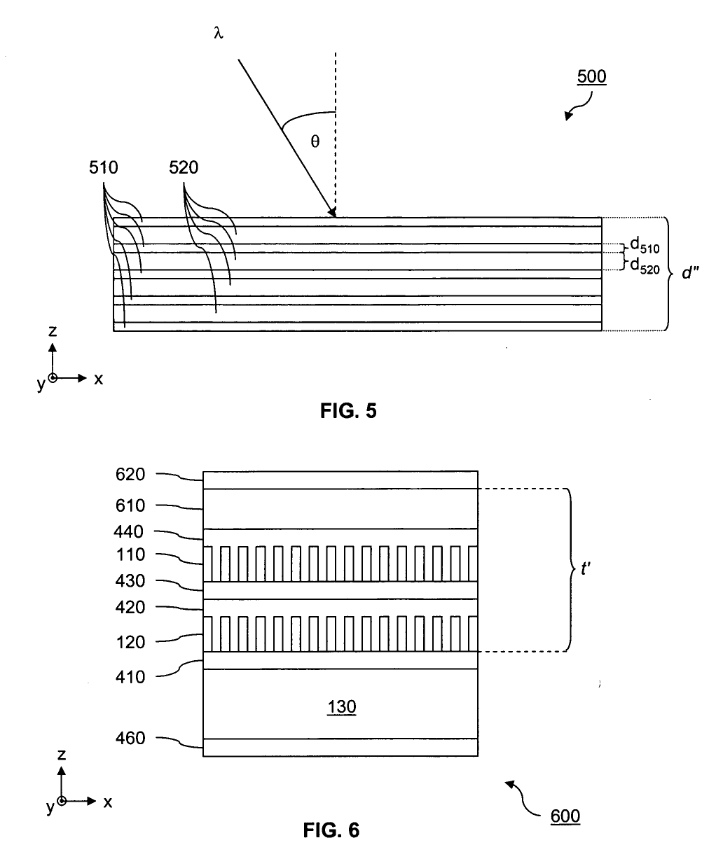

While the foregoing optical retarders include retardation layers that are have properties corresponding to effective uniaxial optical materials with the optical axis oriented in the plane of the retarder (i.e., a-plates), embodiments can include other types of retardation layer. For example, embodiments can include form birefringent c-plates, which are form birefringent media having an optical axis substantially perpendicular to the plane of the retarder. An example of a form birefringent c-plate is retardation film 500 shown in FIG. 5. Retardation film 500 includes alternating layers 510 and 520 having different refractive indexes at λ.

Because the optical axis is oriented substantially parallel to the z-axis, radiation incident on retarder 500 along this direction propagates as ordinary rays regardless of the radiation's polarization state. However, for radiation incident at a non-normal angle, θ, the layers effective refractive index varies depending on θ and on the polarization state of the incident radiation. Layers 510 and 520 have thicknesses d₅₁₀ and d₅₂₀, respectively. In general, d₅₁₀ and d₅₂₀ are selected so that retardation film 500 has a desired birefringence. d₅₁₀ and d₅₂₀ are approximately the same. For example, in some embodiments, the ratio d₅₁₀/d₅₂₀ is in a range from about 0.8 to about 1.2 (e.g., in a range from about 0.9 to about 1.1, such as about one). In certain embodiments, d₅₁₀ is larger than d₅₂₀. For example, the ratio d510/d₅₂₀ can be more than about 1.2 (e.g., about 1.3 or more, about 1.4 or more, about 1.5 or more, about 1.8 or more, about two or more, about 2.5 or more, about three or more, about four or more, about five or more). In certain embodiments, d₅₁₀ and/or d₅₂₀ is about 5 nm or more (e.g., about 10 nm or more, about 15 nm or more, about 20 nm or more, about 30 nm or more, about 40 nm or more, about 50 nm or more, about 60 nm or more, about 70 nm or more, about 80 nm or more, about 90 nm or more, about 100 nm or more).

Layers 510 and 520 are formed from materials having refractive indexes n₅₁₀ and n₅₂₀ at λ, respectively. In general, n₅₁₀ is different from n₅₂₀. The material and refractive index of layers 510 and 520 can be the same as those listed with respect to rows 111, 112, 121, and 122 described supra with respect to optical retarder 100. In some embodiments, one or both of layers 510 and 520 are formed from a nanolaminate material.

The effective ordinary and extraordinary indexes of refraction are given by Eq. (1a) and (1b), respectively. α and β correspond to d₅₁₀ and d₅₂₀, respectively. n₁ and n₂ correspond to n₅₁₀ and n₅₂₀, respectively.

Retardation film 500 has a birefringence Δn₅₀₀=nₑ−nₒ. In some embodiments, Δn₅₀₀ is relatively large (e.g., about 0.1 or more, about 0.15 or more, about 0.2 or more, about 0.3 or more, about 0.4 or more, about 0.5 or more, about 0.6 or more, about 0.7 or more, about 0.8 or more, about 0.9 or more, about 1.0 or more). A relatively large birefringence can be desirable in embodiments where a high retardation and/or phase retardation are desired, and/or where a relatively thin retardation layer is desired. In certain embodiments, Δn₅₀₀ is relatively small (e.g., about 0.05 or less, about 0.04 or less, about 0.03 or less, about 0.02 or less, about 0.01 or less, about 0.005 or less, about 0.002 or less, 0.001 or less). A relatively small birefringence may be desirable in embodiments where a low retardation or phase retardation are desired, and/or where relatively low sensitivity of the retardation and/or phase retardation to variations in the thickness of retardation film 500 is desired. Δn₅₀₀ can also be between about 0.05 and about 0.1 (e.g., about 0.06, about 0.07, about 0.08, about 0.09).

In certain embodiments, Δn₅₀₀ is negative. For example, Δn₅₀₀ can be about negative with |Δn₅₀₀| being about 0.005 or more (e.g., about 0.01 or more, about 0.02 or more, about 0.03 or more, about 0.04 or more, about 0.05 or more, about 0.07 or more, about 0.1 or more, about 0.12 or more, about 0.15 or more, about 0.2 or more, about 0.3 or more, about 0.4 or more, about 0.5 or more). As an example, optical retarder 500 can include alternating layers of SiO2 and TiO2 with layer thickness of about 20 nm each. For visible light, the refractive index of SiO₂ is about 1.53 while the refractive index of TiO₂ is about 2.13. Thus, based on equations (1a) and (1b), supra, in this case Δn₅₀₀ is about −0.1.

Film 500 has thickness d″. In general, d″ is selected so that retardation film retards radiation at λ incident at θ by a desired amount. In some embodiments, d″ can be relatively thin. For example, d″ can be about five microns or less (e.g., about four microns or less, about three microns or less, about two microns or less, about one micron or less, about 0.8 microns or less, about 0.6 microns or less, about 0.5 microns or less, about 0.4 microns or less, about 0.3 microns or less, about 0.2 microns or less, about 0.1 microns or less) thick.

While retardation film 500 is shown as including nine layers, in general, the number of layers in a form birefringent c-plates can vary as desired. Typically, form birefringent c-plates include about 10 to about 200 layers (e.g., about 15 or more layers, about 20 or more layers, about 30 or more layers, about 40 or more layers, about 50 or more layers, about 60 or more layers, about 70 or more layers) (e.g., about 180 or fewer layers, about 150 or fewer layers, about 120 or fewer layers, about 100 or fewer layers, about 90 or fewer layers, about 80 or fewer layers).

Moreover, retardation film 500 can include one or more additional layers having thicknesses different from d₅₁₀ and d₅₂₀ and/or layers formed from materials with refractive indexes different from n₅₁₀ and n₅₂₀. In general, the structure of retardation film 500 can be based on theoretical models, and can be optimized to provide a desired amount of retardation at one or more wavelengths based on the theoretical models.

Examples of form birefringent c-plates are described by M. Kitagawa and M. Tateda in “Form birefringence of SiO₂/Ta₂O₅ periodic multilayers,” Appl. Opt., Vol. 24, No. 20, pp. 3359-3362 (1985).

An example of an optical retarder that includes both a-plate retardation layers and c-plate retardation layers is shown in FIG. 6. The structure of optical retarder 600 corresponds to the structure of optical retarder 400, except that a c-plate retardation film 620, rather than antireflection film 450 is disposed on top of cap layer 440. An antireflection film 620 is disposed on retardation film 610.

The combined thickness t′ of optical retardation layers 110 and 120 and optical retardation film 610 can be relatively small. For example, t′ can be about 15 microns or less, about 12 microns or less (e.g., about 10 microns or less, about eight microns or less, about six microns or less, about five microns or less, about four microns or less).

In general, the respective location of the retardation layers in optical retarder 600 can vary as desired. For example, while both a-plate retardation layer 120 and a-plate retardation layer 110 are both positioned between c-plate retardation film 610 and substrate 130, in some embodiments, a c-plate retardation film can be positioned between two a-plate retardation layers or between the substrate and the a-plate retardation layers. Moreover, optical retarders can, in general, include more or fewer a-plate retardation layers or more c-plate retardation films.

The foregoing retarders include period arrangements of different materials. However, more generally, optical retarders (e.g., a-plate optical retarders, c-plate optical retarders) can include non-periodic arrangements of different materials in additional, or as alternative to, periodic arrangements. For example, a-plate optical retarders can include regions of periodicity variation (e.g., chirped grating structures). Optical retarders of c-plate type can also include non-periodic arrangements of different materials. As an example, a c-plate optical retarder can be fabricated having alternating layers of a high index material and a low index material (referred to as bilayers), the high index layers having thicknesses of about 10 nm and the low index layers having thicknesses of about 15 nm. A stack of about 90 bilayers can be produced. Atop the stack, an alternating sequence of high and low index layers can be deposited, the high and low index layers having variable thicknesses to provide a non-periodic portion of the overall structure. For example, the thicknesses of the layers can be selected to vary in a regular manner to provide a chirped variation in index of refraction.

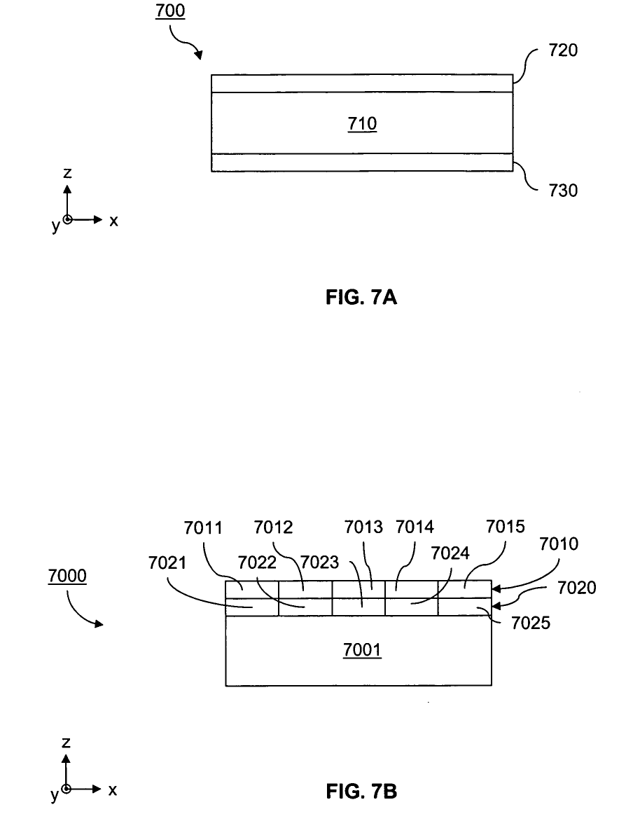

While the foregoing optical retarders include retardation layers on one side of a substrate, embodiments can include retardation layers on opposite sides of a substrate. For example, referring to FIG. 7A, and optical retarder 700 includes a first retardation film 720 and a second retardation film 730 on opposing sides of a substrate 710. Retardation film 720 and/or 730 can include one or more retardation layers (e.g., a-plate retardation layers or layers forming a c-plate optical retardation film).

In some embodiments, retardation layers and/or retardation films can be pixellated. In other words, the retardation layers and/or retardation films can include portions with structure that differs from other portions. The portions are referred to as pixels. For example, a pixellated a-plate can include portions with where the spaced apart rows of material are oriented along different directions. The spaced apart rows of different portions can be, for example, oriented at about 45° or at about 90° with respect to each other. Alternatively, or additionally, a pixellated a-plate can include pixels with different grating periods.

c-plate retardation films can also be pixellated. For example, a pixellated c-plate can include pixels with differing layer structure, providing differing retardation properties.

Referring to FIG. 7B, an example of a pixellated optical retarder 7000 is shown. Optical retarder includes a substrate 7001, and two pixellated retardation layers 7010 and 7020. Retardation layer 7010 includes pixels 7011, 7012, 7013, 7014, and 7015, while retardation layer 7020 includes pixels 7021, 7022, 7023, 7024, and 7025. Pixels 7011, 7012, 7013, 7014, and 7015 are registered with pixels 7021, 7022, 7023, 7024, and 7025, respectively. Although layers 7010 and 7020 are depicted as including only five pixels each, more generally, the number of pixels in each layer can vary as desired. In some embodiments, for example, layers can include thousands to millions of pixels.

In general, pixels can be arranged in a one-dimensional array or a two-dimensional array. The pixel size, number and density can be selected to correspond to the pixel size, number, and density of a pixellated device, such as a detector array (e.g., for a digital camera) or a display device (e.g., a liquid crystal display device).

While the pixels in retardation layers 7010 and 7020 are the same area (in the x-y plane), in some embodiments, pixels in different layers can have different areas. In certain embodiments, the pixel area in one layer can correspond to an integer number of pixels (e.g., two pixels, three pixels, four pixels, five or more pixels) in another layer. In certain embodiments, one of retardation layers can be pixellated, while the other layer is not pixellated. A non pixellated layer is referred to as a single pixel layer.

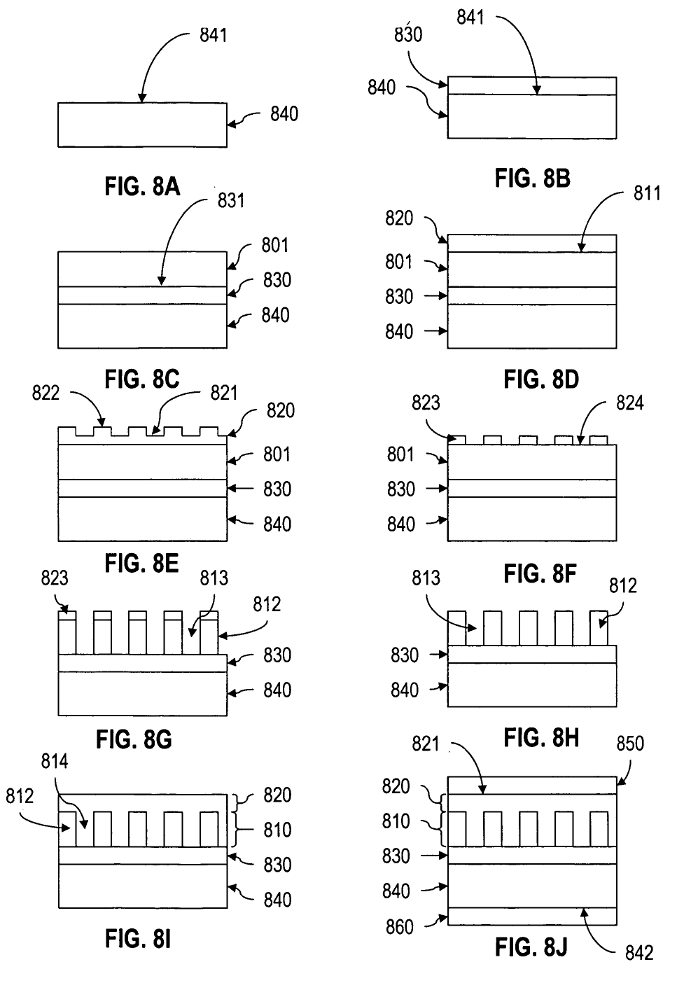

In general, optical retarders can be fabricated using a variety of methods. Optical retarders can be formed using methods commonly used to fabricate microelectronic components, including a variety of deposition and lithographic patterning techniques. FIGS. 8A-8J show different phases of an example of a preparation process. Initially, a substrate 840 is provided, as shown in FIG. 28A. A surface 841 of substrate 840 can be polished and/or cleaned (e.g., by exposing the substrate to one or more solvents, acids, and/or baking the substrate).

Referring to FIG. 8B, an etch stop layer 830 is deposited on surface 841 of substrate 840. The material forming etch stop layer 830 can be formed using one of a variety of techniques, including sputtering (e.g., radio frequency sputtering), evaporating (e.g., electron beam evaporation, ion assisted deposition (IAD) electron beam evaporation), or chemical vapor deposition (CVD) such as plasma enhanced CVD (PECVD), ALD, or by oxidization. As an example, a layer of HfO₂ can be deposited on substrate 140 by IAD electron beam evaporation.

Referring to FIG. 8C, an intermediate layer 801 is then deposited on a surface 831 of etch stop layer 830. Portions 812 are etched from intermediate layer 810, so intermediation layer 801 is formed from the material used for portions 812. The material forming intermediate layer 801 can be deposited using one of a variety of techniques, including sputtering (e.g., radio frequency sputtering), evaporation (e.g., election beam evaporation), or chemical vapor deposition (CVD) (e.g., plasma enhanced CVD).

In certain embodiments intermediate layer 801 is formed from a dielectric, such as SiO₂. Dielectric layers can be formed by using, for example, vapor deposition methods, (e.g., CVD, such as plasma enhanced CVD), evaporation methods (e.g., electron beam or thermal evaporation methods), sputtering, or atomic layer deposition (ALD).

In general, the thickness of intermediate layer 801 is selected based on the desired thickness of the retardation layer that will be formed from intermediate layer 801.

Intermediate layer 801 is processed to provide portions 812 of a subsequent retardation layer using lithographic techniques. For example, portions 812 can be formed from intermediate layer 801 using electron beam lithography or photolithography (e.g., using a photomask or using holographic techniques).

In some embodiments, portions 812 are formed using nano-imprint lithography. Referring to FIG. 8D, nano-imprint lithography includes forming a layer 820 of a resist on surface 811 of intermediate layer 801. The resist can be polymethylmethacrylate (PMMA) or polystyrene (PS), for example. Referring to FIG. 8E, a pattern is impressed into resist layer 820 using a mold. The patterned resist layer 820 includes thin portions 821 and thick portions 822. Patterned resist layer 820 is then etched (e.g., by oxygen reactive ion etching (RIE)), removing thin portions 821 to expose portions 824 of surface 811 of intermediate layer 801, as shown in FIG. 8F. Thick portions 822 are also etched, but are not completely removed. Accordingly, portions 823 of resist remain on surface 811 after etching.

Referring to FIG. 8G, the exposed portions of intermediate layer 801 are subsequently etched, forming trenches 812 in intermediate layer 801. The unetched portions of intermediate layer 801 correspond to portions 812 of retardation layer 810. Intermediate layer 801 can be etched using, for example, reactive ion etching, ion beam etching, sputtering etching, chemical assisted ion beam etching (CAIBE), or wet etching. The exposed portions of intermediate layer 801 are etched down to etch stop layer 830, which is formed from a material resistant to the etching method. Accordingly, the depth of trenches 813 formed by etching is the same as the thickness of portions 812. After etching trenches 813, residual resist 823 is removed from portions 812. Resist can be removed by rinsing the article in a solvent (e.g., an organic solvent, such as acetone or alcohol), by O₂ plasma ashing, O₂ RIE, or ozone cleaning.

Etching can be performed using commercially-available equipment, such as a TCP® 9600DFM (available from Lam Research, Fremont, Calif.).

More than one etch step can be used. For example, in some embodiments, a two-step etch is used. An example of a two step etching process is as follows. A substrate such as a blank fused silica substrate, or a glass substrate having a layer of SiO₂ of thickness about 1000 nm deposited thereon, is cleaned and prepared for deposition. An aluminum layer of thickness approximately 150 nm is deposited thereon using a high vacuum electron-beam deposition process. Atop the aluminum layer, a thin layer of SiO₂ having a thickness of about 30 nm is deposited using an ion-assisted deposition electron-beam deposition process. Subsequently, a process of nanoimprint lithography is initiated. Firstly, a resist layer of thickness about 180 nm is applied atop the SiO₂ layer by a spin coating process. Secondly, a mold having a thickness or depth of about 120 nm and a period of about 200 nm or about 150 nm, is pressed into the resist layer and then separated therefrom to form a pattern profile. An oxygen reactive ion etching process is then used to etch the residual (recessed) resist and expose the SiO₂ layer underneath. Next, a reactive ion etching process using CHF₃ is used to etch the 30 nm SiO₂ layer using the remaining resist as a mask. Following this process, the remaining resist is removed by an oxygen ashing process.

In a subsequent step, the SiO₂ layer is used as a mask to preferentially etch the 150 nm aluminum layer using a chemical etching process based on Cl₂. Following this process of aluminum removal, SiO₂ is deep-etched using the remaining aluminum as a mask. It is possible to etch to a depth of up to about 800 nm in SiO₂ using the 150 nm aluminum mask. In a final step, the aluminum mask is removed using either a dry (Cl₂) or wet chemical process.

Referring to FIG. 8I, after removing residual resist, material is deposited onto the article, filling trenches 813 and forming cap layer 820. The filled trenches correspond to portions 814 of retardation layer 810. Material can be deposited onto the article in a variety of ways, including sputtering, electron beam evaporation, CVD (e.g., high density CVD) or atomic layer deposition (ALD). Note that where cap layer 820 is formed and trenches 813 are filled during the same deposition step, portions 813 and cap layer 820 are formed from a continuous portion of material.

Finally, additional layers 150 and 160, such as antireflection films are deposited onto surface 821 of cap layer 820 and surface 842 of substrate 840, respectively. Additional layers may be formed on layers 150 and/or 160. For example, the process described above for fabricating retardation layer 810 may be repeating to fabricate a second retardation layer on a surface of the article. Alternatively, or additionally, a c-plate retardation film can be formed on one or more surfaces of the article. Materials forming the additional layers can be deposited onto the article by sputtering, electron beam evaporation, or ALD, for example.

Additional fabrication steps can be used at various points during the described process. For example, surfaces can be planarized and/or layers can be reduced in thickness by polishing (e.g., chemical mechanical polishing) or milling (e.g., using an ion beam), for example. In some embodiments, multiple optical retarders can be prepared simultaneously by forming a relatively large retardation layer on a single substrate, which is then diced into individual units. For example, a retardation layer can be formed on a substrate that has a single-side surface area about 10 square inches or more (e.g., a four inch, six inch, or eight inch diameter substrate). After forming the grating layer, the substrate can be diced into multiple units of smaller size (e.g., having a single-side surface area of about one square inch or less).

As discussed previously, in some embodiments, holographic lithography techniques can be used to form a pattern in a layer of resist material on intermediate layer 801. In these techniques, a photosensitive resist layer is exposed to an interference pattern formed by overlapping two or more coherence beams of radiation, usually derived from a laser light source. The varying light intensity of the interference pattern is transferred to the resist material, which can be developed after exposure to provide a patterned resist layer.

Holographic lithography can be used to generate a period intensity pattern by interfering two coherent beams of similar intensity. The technique is particularly versatile as the period of the intensity pattern can be varied by varying the angle at which the two beams interfere.

Theoretically, the period of the intensity pattern, Γ, is given by the equation:

$$Γ = \frac{{λ}_{b}}{2 n sin φ} , \qquad ( 9 )$$

where λ_{b} is the wavelength of the interfering radiation, n is the refractive index of the medium in which the beams interfere, and φ is half the angle subtended by the interfering beams. Since Γ is proportional to λ_{b}, interference patterns having relatively short periods (e.g., about 300 nm or less) can be formed by selecting a light source with a relatively short wavelength (e.g., an argon laser having output at 351 nm). Furthermore, the interference pattern period can be reduced by interfering the two beams at relatively large angles (e.g., φ about 45 degrees or more). For example, the resist can be exposed to two 351 nm beams with φ at about 61 degrees to provide a grating having a period of about 200 nm.

In some embodiments, holographic lithography can be performed while immersing the substrate and resist in a medium having a refractive index higher than the refractive index of air. For example, the resist surface can be immersed in a liquid such as water (which has a refractive index of about 1.33) or an organic liquid (e.g., glycerin, which has a refractive index of about 1.5)

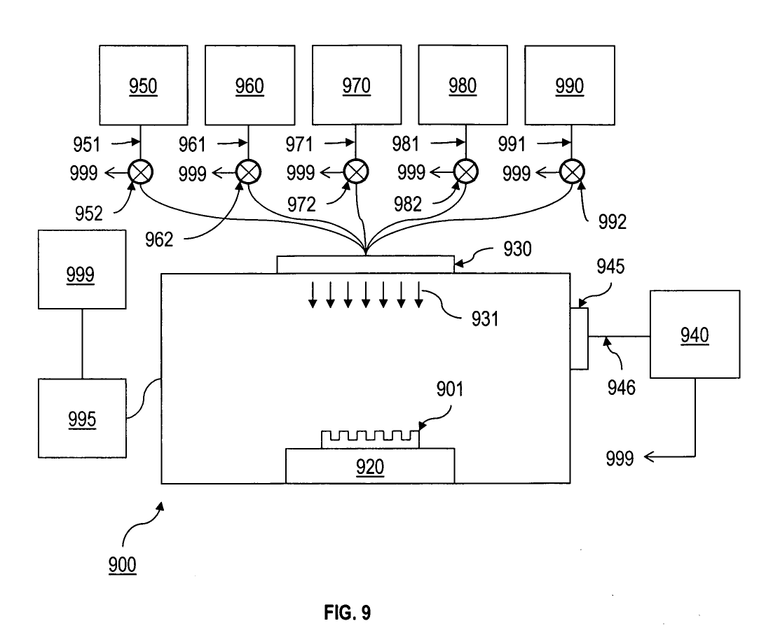

As mentioned previously, in some embodiments, layers of optical retarders can be prepared using atomic layer deposition (ALD). For example, referring to FIG. 9, an ALD system 900 is used to fill trenches 912 of an intermediate article 901 (e.g., composed of a substrate, a cap layer, and a layer of a series of spaced-apart rows) with a nanolaminate multilayer film. Deposition of the nanolaminate multilayer film occurs monolayer by monolayer, providing substantial control over the composition and thickness of the films. During deposition of a monolayer, vapors of a precursor are introduced into the chamber and are adsorbed onto exposed surfaces of portions 912, the exposed surface of the etch stop layer or previously deposited monolayers adjacent these surfaces. Subsequently, a reactant is introduced into the chamber that reacts chemically with the adsorbed precursor, forming a monolayer of a desired material. The self-limiting nature of the chemical reaction on the surface can provide precise control of film thickness and large-area uniformity of the deposited layer. Moreover, the non-directional adsorption of precursor onto each exposed surface provides for uniform deposition of material onto the exposed surfaces, regardless of the orientation of the surface relative to chamber 910. Accordingly, the layers of the nanolaminate film conform to the shape of the trenches of intermediate article 901.

ALD system 900 includes a reaction chamber 910, which is connected to sources 950, 960, 970, 980, and 990 via a manifold 930. Sources 950, 960, 970, 980, and 990 are connected to manifold 930 via supply lines 951, 961, 971, 981, and 991, respectively. Valves 952, 962, 972, 982, and 992 regulate the flow of gases from sources 950, 960, 970, 980, and 990, respectively. Sources 950 and 980 contain a first and second precursor, respectively, while sources 960 and 990 include a first reagent and second reagent, respectively. Source 970 contains a carrier gas, which is constantly flowed through chamber 910 during the deposition process transporting precursors and reagents to article 901, while transporting reaction byproducts away from the substrate. Precursors and reagents are introduced into chamber 910 by mixing with the carrier gas in manifold 930. Gases are exhausted from chamber 910 via an exit port 945. A pump 940 exhausts gases from chamber 910 via an exit port 945. Pump 940 is connected to exit port 945 via a tube 946.

ALD system 900 includes a temperature controller 995, which controls the temperature of chamber 910. During deposition, temperature controller 995 elevates the temperature of article 901 above room temperature. In general, the temperature should be sufficiently high to facilitate a rapid reaction between precursors and reagents, but should not damage the substrate. In some embodiments, the temperature of article 901 can be about 500° C. or less (e.g., about 400° C. or less, about 300° C. or less, about 200° C. or less, about 150° C. or less, about 125° C. or less, about 100° C. or less).

Typically, the temperature should not vary significantly between different portions of article 901. Large temperature variations can cause variations in the reaction rate between the precursors and reagents at different portions of the substrate, which can cause variations in the thickness and/or morphology of the deposited layers. In some embodiments, the temperature between different portions of the deposition surfaces can vary by about 40° C. or less (e.g., about 30° C. or less, about 20° C. or less, about 10° C. or less, about 5° C. or less).

Deposition process parameters are controlled and synchronized by an electronic controller 999. Electronic controller 999 is in communication with temperature controller 995; pump 940; and valves 952, 962, 972, 982, and 992. Electronic controller 999 also includes a user interface, from which an operator can set deposition process parameters, monitor the deposition process, and otherwise interact with system 900.

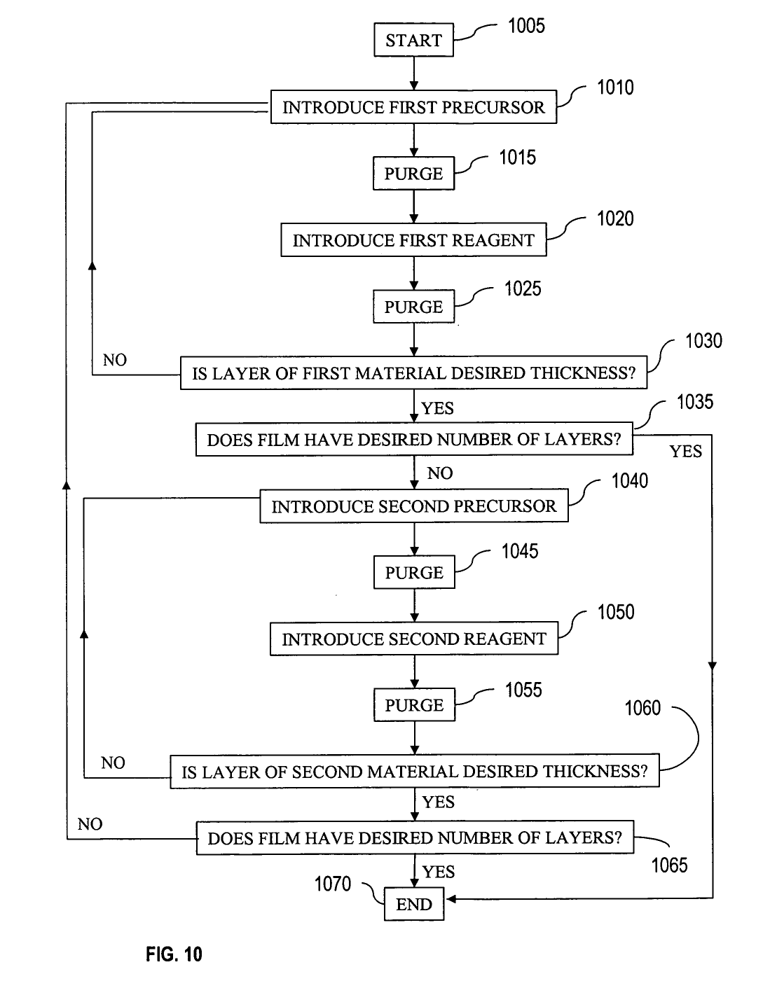

Referring to FIG. 10, the ALD process is started (1005) when system 900 introduces the first precursor from source 950 into chamber 910 by mixing it with carrier gas from source 970 (1010). A monolayer of the first precursor is adsorbed onto exposed surfaces of article 901, and residual precursor is purged from chamber 910 by the continuous flow of carrier gas through the chamber (1015). Next, the system introduces a first reagent from source 960 into chamber 910 via manifold 930 (1020). The first reagent reacts with the monolayer of the first precursor, forming a monolayer of the first material. As for the first precursor, the flow of carrier gas purges residual reagent from the chamber (1025). Steps 1010 through 1030 are repeated until the layer of the first material reaches a desired thickness (1030).

In embodiments where the films are a single layer of material, the process ceases once the layer of first material reaches the desired thickness (1035). However, for a nanolaminate film, the system introduces a second precursor into chamber 910 through manifold 930 (1040). A monolayer of the second precursor is adsorbed onto the exposed surfaces of the deposited layer of first material and carrier gas purges the chamber of residual precursor (1045). The system then introduces the second reagent from source 1040 into chamber 1005 via manifold 1015. The second reagent reacts with the monolayer of the second precursor, forming a monolayer of the second material (1050). Flow of carrier gas through the chamber purges residual reagent (1055). Steps 1040 through 1055 are repeated until the layer of the second material reaches a desired thickness (1060).

Additional layers of the first and second materials are deposited by repeating steps 1060 through 1065. Once the desired number of layers are formed (e.g., the trenches are filled and/or cap layer has a desired thickness), the process terminates (1070), and the coated article is removed from chamber 910.

Although the precursor is introduced into the chamber before the reagent during each cycle in the process described above, in other examples the reagent can be introduced before the precursor. The order in which the precursor and reagent are introduced can be selected based on their interactions with the exposed surfaces. For example, where the bonding energy between the precursor and the surface is higher than the bonding energy between the reagent and the surface, the precursor can be introduced before the reagent. Alternatively, if the binding energy of the reagent is higher, the reagent can be introduced before the precursor.

The thickness of each monolayer generally depends on a number of factors. For example, the thickness of each monolayer can depend on the type of material being deposited. Materials composed of larger molecules may result in thicker monolayers compared to materials composed of smaller molecules.

The temperature of the article can also affect the monolayer thickness. For example, for some precursors, a higher temperate can reduce adsorption of a precursor onto a surface during a deposition cycle, resulting in a thinner monolayer than would be formed if the substrate temperature were lower.

The type or precursor and type of reagent, as well as the precursor and reagent dosing can also affect monolayer thickness. In some embodiments, monolayers of a material can be deposited with a particular precursor, but with different reagents, resulting in different monolayer thickness for each combination. Similarly, monolayers of a material formed from different precursors can result in different monolayer thickness for the different precursors.

Examples of other factors which may affect monolayer thickness include purge duration, residence time of the precursor at the coated surface, pressure in the reactor, physical geometry of the reactor, and possible effects from the byproducts on the deposited material. An example of where the byproducts affect the film thickness are where a byproduct etches the deposited material. For example, HCl is a byproduct when depositing TiO₂ using a TiCl₄ precursor and water as a reagent. HCl can etch the deposited TiO₂ before it is exhausted. Etching will reduce the thickness of the deposited monolayer, and can result in a varying monolayer thickness across the substrate if certain portions of the substrate are exposed to HCl longer than other portions (e.g., portions of the substrate closer to the exhaust may be exposed to byproducts longer than portions of the substrate further from the exhaust).

Typically, monolayer thickness is between about 0.1 nm and about five nm. For example, the thickness of one or more of the deposited monolayers can be about 0.2 nm or more (e.g., about 0.3 nm or more, about 0.5 nm or more). In some embodiments, the thickness of one or more of the deposited monolayers can be about three nm or less (e.g., about two nm, about one nm or less, about 0.8 nm or less, about 0.5 nm or less).

The average deposited monolayer thickness may be determined by depositing a preset number of monolayers on a substrate to provide a layer of a material. Subsequently, the thickness of the deposited layer is measured (e.g., by ellipsometry, electron microscopy, or some other method). The average deposited monolayer thickness can then be determined as the measured layer thickness divided by the number of deposition cycles. The average deposited monolayer thickness may correspond to a theoretical monolayer thickness. The theoretical monolayer thickness refers to a characteristic dimension of a molecule composing the monolayer, which can be calculated from the material's bulk density and the molecules molecular weight. For example, an estimate of the monolayer thickness for SiO₂ is ˜0.37 nm. The thickness is estimated as the cube root of a formula unit of amorphous SiO₂ with density of 2.0 grams per cubic centimeter.

In some embodiments, average deposited monolayer thickness can correspond to a fraction of a theoretical monolayer thickness (e.g., about 0.2 of the theoretical monolayer thickness, about 0.3 of the theoretical monolayer thickness, about 0.4 of the theoretical monolayer thickness, about 0.5 of the theoretical monolayer thickness, about 0.6 of the theoretical monolayer thickness, about 0.7 of the theoretical monolayer thickness, about 0.8 of the theoretical monolayer thickness, about 0.9 of the theoretical monolayer thickness). Alternatively, the average deposited monolayer thickness can correspond to more than one theoretical monolayer thickness up to about 30 times the theoretical monolayer thickness (e.g., about twice or more than the theoretical monolayer thickness, about three time or more than the theoretical monolayer thickness, about five times or more than the theoretical monolayer thickness, about eight times or more than the theoretical monolayer thickness, about 10 times or more than the theoretical monolayer thickness, about 20 times or more than the theoretical monolayer thickness).

During the deposition process, the pressure in chamber 910 can be maintained at substantially constant pressure, or can vary. Controlling the flow rate of carrier gas through the chamber generally controls the pressure. In general, the pressure should be sufficiently high to allow the precursor to saturate the surface with chemisorbed species, the reagent to react completely with the surface species left by the precursor and leave behind reactive sites for the next cycle of the precursor. If the chamber pressure is too low, which may occur if the dosing of precursor and/or reagent is too low, and/or if the pump rate is too high, the surfaces may not be saturated by the precursors and the reactions may not be self limited. This can result in an uneven thickness in the deposited layers. Furthermore, the chamber pressure should not be so high as to hinder the removal of the reaction products generated by the reaction of the precursor and reagent. Residual byproducts may interfere with the saturation of the surface when the next dose of precursor is introduced into the chamber. In some embodiments, the chamber pressure is maintained between about 0.01 Torr and about 100 Torr (e.g., between about 0.1 Torr and about 20 Torr, between about 0.5 Torr and 10 Torr, such as about 1 Torr).

Generally, the amount of precursor and/or reagent introduced during each cycle can be selected according to the size of the chamber, the area of the exposed substrate surfaces, and/or the chamber pressure. The amount of precursor and/or reagent introduced during each cycle can be determined empirically.

The amount of precursor and/or reagent introduced during each cycle can be controlled by the timing of the opening and closing of valves 952, 962, 982, and 992. The amount of precursor or reagent introduced corresponds to the amount of time each valve is open each cycle. The valves should open for sufficiently long to introduce enough precursor to provide adequate monolayer coverage of the substrate surfaces. Similarly, the amount of reagent introduced during each cycle should be sufficient to react with substantially all precursor deposited on the exposed surfaces. Introducing more precursor and/or reagent than is necessary can extend the cycle time and/or waste precursor and/or reagent. In some embodiments, the precursor dose corresponds to opening the appropriate valve for between about 0.1 seconds and about five seconds each cycle (e.g., about 0.2 seconds or more, about 0.3 seconds or more, about 0.4 seconds or more, about 0.5 seconds or more, about 0.6 seconds or more, about 0.8 seconds or more, about one second or more). Similarly, the reagent dose can correspond to opening the appropriate valve for between about 0.1 seconds and about five seconds each cycle (e.g., about 0.2 seconds or more, about 0.3 seconds or more, about 0.4 seconds or more, about 0.5 seconds or more, about 0.6 seconds or more, about 0.8 seconds or more, about one second or more).

The time between precursor and reagent doses corresponds to the purge. The duration of each purge should be sufficiently long to remove residual precursor or reagent from the chamber, but if it is longer than this it can increase the cycle time without benefit. The duration of different purges in each cycle can be the same or can vary. In some embodiments, the duration of a purge is about 0.1 seconds or more (e.g., about 0.2 seconds or more, about 0.3 seconds or more, about 0.4 seconds or more, about 0.5 seconds or more, about 0.6 seconds or more, about 0.8 seconds or more, about one second or more, about 1.5 seconds or more, about two seconds or more). Generally, the duration of a purge is about 10 seconds or less (e.g., about eight seconds or less, about five seconds or less, about four seconds or less, about three seconds or less).

The time between introducing successive doses of precursor corresponds to the cycle time. The cycle time can be the same or different for cycles depositing monolayers of different materials. Moreover, the cycle time can be the same or different for cycles depositing monolayers of the same material, but using different precursors and/or different reagents. In some embodiments, the cycle time can be about 20 seconds or less (e.g., about 15 seconds or less, about 12 seconds or less, about 10 seconds or less, about 8 seconds or less, about 7 seconds or less, about 6 seconds or less, about 5 seconds or less, about 4 seconds or less, about 3 seconds or less). Reducing the cycle time can reduce the time of the deposition process.

The precursors are generally selected to be compatible with the ALD process, and to provide the desired deposition materials upon reaction with a reagent. In addition, the precursors and materials should be compatible with the material on which they are deposited (e.g., with the substrate material or the material forming the previously deposited layer). Examples of precursors include chlorides (e.g., metal chlorides), such as TiCl₄, SiCl₄, SiH₂Cl₂, TaCl₃, HfCl₄, InCl₃ and AlCl₃. In some embodiments, organic compounds can be used as a precursor (e.g., Ti-ethaOxide, Ta-ethaOxide, Nb-ethaOxide). Another example of an organic compound precursor is (CH₃)₃Al. For SiO₂ deposition, for example, suitable precursors include Tris(tert-butoxy), Tris(tert-pentoxy) silanol, or tetraethoxysilane (TEOS).

The reagents are also generally selected to be compatible with the ALD process, and are selected based on the chemistry of the precursor and material. For example, where the material is an oxide, the reagent can be an oxidizing agent. Examples of suitable oxidizing agents include water, hydrogen peroxide, oxygen, ozone, (CH₃)₃Al, and various alcohols (e.g., Ethyl alcohol CH₃OH). Water, for example, is a suitable reagent for oxidizing precursors such as TiCl₄ to obtain TiO₂, AlCl₃ to obtain Al₂O₃, and Ta-ethaoxide to obtain Ta₂O₅, Nb-ethaoxide to obtain Nb₂O₅, HfCl₄ to obtain HfO₂, ZrCl₄ to obtain ZrO₂, and InCl₃ to obtain In₂O₃. In each case, HCl is produced as a byproduct. In some embodiments, (CH₃)₃Al can be used to oxidize silanol to provide SiO₂.

In some embodiments, an optical retarder can be combined with a linear polarizing film to provide a polarizer that delivers light of a certain non-linear polarization (e.g., circularly polarized light or a specific elliptical polarization state). An example of such a device is polarizer 1100, shown in FIG. 11. Polarizer 1100 includes polarizing film 1110 (e.g., an absorptive polarizing film, such as iodine-stained polyvinyl alcohol, or a reflective polarizer) and optical retarder 1120. Film 1110 linearly polarizes incident isotropic light propagating along axis 1110. Subsequently, optical retarder 620 retards the polarized light exiting polarizing film 1110, resulting in polarized light having a specific ellipticity and orientation of the elliptical axes. Alternatively, optical retarder 1120 can be designed to rotate the electric field direction of the linearly polarized light exiting film 1110. Polarizer 1100 can be included in a variety of optical systems, such as, for example, a liquid crystal display (LCD) (e.g., a Liquid Crystal on Silicon (LCoS) LCD).

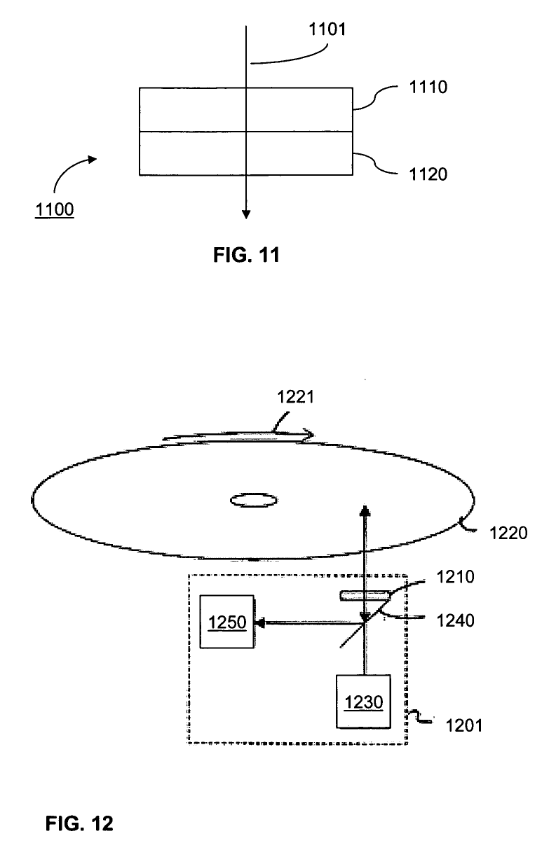

As another example, referring to FIG. 12, in some embodiments, an optical retarder 1210 can be included in an optical pickup 1201 used for reading and/or writing to an optical storage medium 1220 (e.g., a CD or DVD). In addition to optical retarder 1210, optical pickup 1201 also includes a light source 1230 (e.g., one or more laser diodes), a polarizing beam splitter 1240, and a detector 1250. In some embodiments, optical retarder has quarter wave retardation at wavelengths λ₁ and λ₂ (e.g., about 660 nm and about 785 nm, respectively). Alternatively, or additionally, in certain embodiments, optical retarder can also have quarter-wave retardation at other wavelengths, such as about 405 nm for example. During operation, light source 1230 illuminates a surface of medium 1220 with linearly polarized radiation at λ₁ and/or λ₂ as the medium spins (indicated by arrow 1221). The polarized radiation passes through polarizing beam splitter (PBS) 1240. Optical retarder 1210 retards the polarized radiation, changing it from linearly polarized radiation to substantially circularly polarized radiation. The circularly polarized radiation changes handedness upon reflection from medium 1220, and is converted back to linearly polarized radiation upon its second pass through optical retarder 1210. At beam splitter 1240, the reflected radiation is polarized orthogonally relative to the original polarization state of the radiation emitted from light source 1230. Accordingly, polarizing beam splitter reflects the radiation returning from medium 1220, directed it to detector 1250. The retarder can be integrated with the PBS in this device. The PBS can be a metal wire-grid polarizer.

In some embodiments, optical retarders can be used as components in a liquid crystal display (LCD). For example, optical retarders can be used to improve the viewing angle characteristics of LCDs. The transmission properties of an LCD generally depends on the angle of viewing for many modes of operation based on a thin film of liquid crystal material, including, for example, twisted nematic (TN) LCDs, vertically-aligned (VA) LCDs, bend aligned (BA) LCDs, and super-twisted-nematic (STN) LCDs. Optical retarders can be used to improve the viewing angle characteristics of LCDs by, for example, introducing compensatory retardation of off-axis light relative to on-axis light.

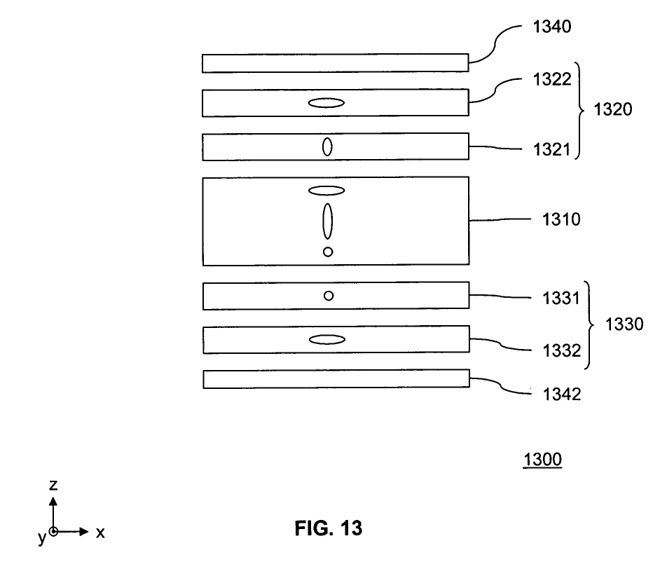

As an example, referring FIG. 13, an LCD 1300 includes, among other components, an LC film 1310, optical retarders 1320 and 1330, a polarizer 1340 and an analyzer 1342. Optical retarder 1320 includes an a-plate retardation layer 1321 and a c-plate retardation film 1322. Optical retarder 1330 includes an a-plate retardation layer 1331 and a c-plate retardation film 1332.

The substrate surfaces (not shown in FIG. 13) of adjacent LC layer 1310 are treated so that the LC molecules align substantially parallel to the x-axis and y-axis adjacent retardation layers 1330 and 1332, respectively. The optical axis of a-plate retardation layer 1330 is substantially parallel to the x-axis and the optical axis of a-plate retardation layer 1332 is substantially parallel to they-axis. The polarizer and analyzer are configured so that the display appears bright when no voltage is applied across the LC film (i.e., the display is normally white).

The a-plate retardation layers are employed to reduce the phase retardation due to the LC regions near the surfaces of the LC film. The optic axes of the a-plates are aligned substantially parallel to the rubbing directions of the adjacent surfaces. The c-plate retardation films are aligned with their optic axes substantially parallel to the z-axis. The c-plate retardation films compensate for the effect of homeotropic LC molecules in the middle of the LC film when a voltage is applied to the film. In general, the retardation of the each of the retardation films and retardation layers are selected based on the retardation of the LC film. The retardation of each film/layer can be determined from theoretical modeling and/or empirically.

Viewing angle compensation of LCDs is discussed further by P. Yeh and C. Gu in “Optics of Liquid Crystal Displays,” John Wiley & Sons, Inc., New York (1999), for example. Compensators are also described in Yeh et al. in U.S. Pat. No. 5,196,953.

Furthermore, while the foregoing examples of LCD compensators are in relation to transmissive LCDs, more generally, optical retarders can also be used to compensate other types of LCD. For example, optical retarders can be used to compensate reflective LCDs, such as liquid crystal on silicon (LCOS) LCDs.

In certain embodiments, optical retarders can be used in applications that utilize ultraviolet radiation. Optical retarders may be relatively stable when exposed to UV radiation, for example, when they do not include any organic materials. Accordingly, optical retarders can be used as retarders in UV lasers and systems that use UV lasers, such as lithography tools.

Other embodiments are in the claims.

What is claimed is:

1. An article, comprising:
a first layer comprising spaced-apart rows of a first material, and
a multilayer film adjacent the first layer,
wherein the first layer and the multilayer film are each independently birefringent for light of a wavelength λ propagating along an axis that intersects the first layer and the multilayer film, and λ is in a range from about 150 nm to about 5,000 nm.

2. The article of claim 1, further comprising a substrate supporting the first layer and the multilayer film.

3. The article of claim 2, wherein the first layer and the multilayer film are disposed on opposite sides of the substrate.

4. The article of claim 2, wherein the first layer and the multilayer film are disposed on the same side of the substrate.

5. The article of claim 2, further comprising a second multilayer film disposed on an opposite side of the substrate to the first multilayer film, the second multilayer film being birefringent for light of wavelength λ propagating along the axis that intersects the first layer and the multilayer film.

6. The article of claim 5, wherein the structures of the first and second multilayer films are identical.

7. The article of claim 1, wherein the first layer is supported by the multilayer film.

8. The article of claim 1, wherein the multilayer film is supported by the first layer.

9. The article of claim 1, further comprising a second layer disposed between the first layer and the multilayer film.

10. The article of claim 1, wherein rows of the first layer define a first plane and the layers of the multilayer film each define a respective plane parallel to and offset from the first plane.

11. The article of claim 1, wherein the multilayer film comprises alternating layers formed of second and third materials.

12. The article of claim 11, wherein at least one of the second and third materials is a nanolaminate material.

13. The article of claim 12, wherein the first material and at least one of the second and third materials are materials independently selected from a group consisting of SiO₂, SiNₓ, Si, Al₂O₃, ZrO₂, Ta₂O₅, TiO₂, HfO₂, Nb₂O₅, and MgF₂.

14. The article of claim 1, wherein the first layer further comprises rows of a second material alternating with the spaced-apart rows of the first material.

15. The article of claim 14, wherein the second material defines a substrate, the rows of the second material are defined by walls of trenches within the substrate, and the first material is disposed within the trenches.

16. The article of claim 15, wherein the first layer further comprises a layer of the first material disposed between the rows of the first layer and the multilayer film.

17. The article of claim 1, wherein the multilayer film comprises a total of at least about 15 layers of each of second and third different materials.

18. The article of claim 17, wherein the multilayer film comprises a total of at least about 35 layers of each of the second and third materials.

19. The article of claim 1, wherein the layers of the multilayer film are each about 100 nm thick or less.

20. The article of claim 1, wherein the article further comprises a second layer comprising spaced-apart rows of a second material, and the second layer is independently birefringent for light of a wavelength λ propagating along an axis that intersects the first and second layers and the multilayer film.

21. The article of claim 20, wherein the rows of the first material extend along a first direction and the rows of the second layer extend along a second direction non-parallel with the first direction.

22. The article of claim 20, wherein the first and second layers are disposed on a common side of the multilayer film.

23. The article of claim 20, wherein an angle between the first and second directions is about 80° or less.

24. The article of claim 23, wherein the angle is about 70° or less.

25. The article of claim 20, wherein the angle between the first and second directions is about 10° or more.

26. The article of claim 25, wherein the angle is about 20° or more.

27. The article of claim 20, wherein the first and second layers together retard incident radiation at wavelengths λ₁ and λ₂ by respective amounts Γ₁ and Γ₂, where |λ₁−λ₂| is at least about 15 nm, Γ₁ and Γ₂ are substantially equal, and both λ₁ and λ₂ are in a range from about 150 nm to about 5,000 nm.

28. The article of claim 27, wherein |λ₁−λ₂| is at least about 30 nm.

29. The article of claim 27, wherein |λ₁−λ₂| is at least about 75 nm.

30. The article of claim 27, wherein |λ₁−λ₂| is at least about 100 nm.

31. The article of claim 27, wherein |λ₁−λ₂| is at least about 200 nm.

32. The article of claim 27, wherein |Γ₁−Γ₂| is about 0.03π or less.

33. The article of claim 27, wherein |Γ₁−Γ₂| is about 0.02π or less.

34. The article of claim 27, wherein |Γ₁−Γ₂| is about 0.01π or less.

35. The article of claim 22, comprising an antireflection film disposed between the multilayer film and the first and second layers.

36. The article of claim 22, wherein a combined thickness of the first and second layers and the multilayer film is about 10 microns or less.

37. The article of claim 36, wherein a total thickness of the multilayer film is about 2 microns or less.

38. The article of claim 1, wherein the multilayer film comprises a plurality of layers where alternating layers have different refractive indexes at λ and each of the plurality of layers in the multilayer film has a thickness in a range from about 2 nm to about 500 nm.

39. The article of claim 20, wherein the first and second layers are disposed on opposite sides of the multilayer film.

40. An optical retarder, for light having a wavelength of about 5,000 nm or less, comprising:
a form birefringent a-plate for radiation at a wavelength λ; and
a form birefringent c-plate for radiation at λ,
wherein λ is about 5,000 nm or less.

41. A method, comprising:
using atomic layer deposition to deposit a multilayer film on a surface of a substrate,
wherein the multilayer film is a form birefringent c-plate for light having a wavelength λ and λ is in a range from about 150 nm to about 5,000 nm.

42. The method of claim 41, wherein the substrate comprises a form birefringent a-plate, where the a-plate is birefringent for light having wavelength λ.

43. The method of claim 41, further comprising forming a form birefringent a-plate on the multilayer film, where the a-plate is birefringent for light of wavelength λ.
